(19) United States
(12) Patent Application Publication
(10) Pub. No.: US 2011/0098323 A1
(43) Pub. Date: Apr. 28, 2011

(54) INHIBITORS OF BACTERIAL BIOFILM FORMATION

(75) Inventors: Timothy J. Opperman, Arlington, MA (US); John D. Williams, Worcester, MA (US); Norton P. Peet, North Andover, MA (US); Atiyya R. Khan, Shrewsbury, MA (US); Steven M. Kwasny, Millbury, MA (US)

(73) Assignee: MICROBIOTIX, INC., Worcester, MA (US)

(21) Appl. No.: 12/991,675

(22) PCT Filed: May 19, 2009
(86) PCT No.: PCT/US09/03086

§ 371 Date: Nov. 8, 2010

(51) Int. Cl. A01N 43/40; A01N 43/78; A01N 43/08; A01N 43/50; A01P 1/00

(52) U.S. Cl. 514/342; 514/369; 514/473; 514/391

(57) ABSTRACT

Organic compounds are described for use in inhibiting or preventing formation of bacterial biofilms.

### CROSS-REFERENCE TO RELATED APPLICATIONS

This application claims priority to U.S. provisional application No. 61/128,093, filed May 19, 2008.

### STATEMENT AS TO FEDERALLY SPONSORED RESEARCH

The invention described herein was supported by SBIR grant number 1 R43 AI074161-01 from the National Institutes of Health. The United States Government has certain rights in the invention.

### FIELD OF THE INVENTION

This invention is in the field of bacterial biofilms. In particular, the invention provides organic compounds that inhibit or prevent formation of bacterial biofilms.

### BACKGROUND OF THE INVENTION

Biofilms are bacterial communities encased in a hydrated extracellular matrix, which may consist of proteins, polysaccharides, nucleic acids, or combinations of these molecules (Branda et al., Trends Microbiol., 13: 20-26 (2005)). The development of biofilms on biological and inanimate surfaces presents significant medical problems. Bacteria in the biofilm mode of growth are highly resistant to treatment with antibiotics and to clearance by a host's immune system. Therefore, once these bacterial communities form, they are extremely difficult to eradicate with conventional treatments. Hence, biofilms can lead to chronic systemic infections. For example, bacterial biofilms have been found in human patients associated with a variety of diseases, including, urinary tract infections, middle ear infections, dental plaque, gingivitis, endocarditis, and the respiratory tract of cystic fibrosis patients. Pathogenic bacteria may form biofilms on a variety of medical implants as well, such as indwelling catheters, artificial heart valves, and pacemakers (Ada et al., Nutrition, 12: 208-213 (1996)). The only reliable remedy currently available is to remove the contaminated implant, which increases the risk of additional patient morbidity and mortality as well as patient medical costs.

The emergence of Staphylococcus epidermidis as a pathogen has been associated with the widespread use of indwelling medical devices. S. epidermidis and Staphylococcus aureus are responsible for the majority of device-related infections. These bacteria are the causative organisms for as much as 50%-70% of catheter-related infections, 40%-50% of prosthetic heart valve infections, 20%-50% of joint replacement infections, and 48%-67% of central nervous shunt infections (see, e.g., O'Gara et al., J. Med. Microbiol., 50: 582-587 (2001), and references therein). S. epidermidis is uniquely suited to its role as a biofilm pathogen as it is able to colonize the surface of nearly all synthetic polymer materials tested (Gotz et al., “Colonization of Medical Devices by Coagulase-Negative Staphylococci”, In Infections Associated with Indwelling Medical Devices, 3rd ed., pages 55-88 (Walvogel & Bisno, eds.) (ASM Press, Washington, D.C., 2000). Consequently, the biofilm phenotype is considered to be a virulence factor in the staphylococci.

Several lines of evidence indicate that bacterial colonization of medical devices by pathogens involves the biofilm mode of growth (Costerton et al., Science, 284: 1318-1322 (1999)). Clinical studies have established a correlation between the ability of clinical strains of S. epidermidis to adopt the biofilm mode of growth and virulence (Ziebuhr et al., Infect. Immun., 65: 890-896 (1997); Galdbart et al., J. Infect. Dis., 182: 351-355 (2000)).

The formation and maintenance of staphylococcal biofilms constitute a complex developmental process that requires the concerted activities of several gene products (reviewed in Gotz, Mol. Microbiol., 43: 1367-1378 (2002)). Transcription profiling experiments have revealed that the expression of a large number of genes is altered in cells of S. aureus (Beenken et al., J. Bacteriol., 186: 4665-4684 (2004); Resch et al., Appl. Environ. Microbiol., 71: 2663-2676 (2005)) and S. epidermidis biofilms (Yao et al., J. Infect. Dis., 191: 289-298 (2005)) as compared to free floating (i.e., “planktonic”) bacterial cells. The most clinically relevant characteristic of biofilm bacteria is that they are up to 1000-fold more resistant to antibiotics and biocides than are planktonic bacteria (Stewart, Int. J. Microbiol., 292: 107-113 (2002)). In addition, staphylococcal biofilm bacteria are resistant to phagocytosis by sentinel leukocytes of the immune system (Leid et al., Infect. Immun., 70: 6339-6345 (2002)). Accordingly, it is clear that biofilm bacteria can survive conventional antibiotic treatments, evade a host's immune system, and provide a reservoir of infectious bacteria that can cause recurrent chronic infections.

The mechanisms of intrinsic antibiotic resistance of biofilm bacteria are currently unknown and do not appear to be the types of mechanisms for antibiotic resistance employed by planktonic bacteria such as upregulation of efflux pumps, modifying enzymes, and target mutations (Costerton et al., Sci. Am., 285: 74-81 (2001)). Several possible mechanisms for increased biofilm resistance to antibiotics have been proposed, including slow penetration of the antibiotic into biofilms, decreased growth rate, physiological heterogeneity, differentiation into a “protected phenotypic state” or “persister”, general stress responses induced by biofilm growth, and expression of biofilm-specific resistance genes (reviewed in Mah et al., Trends Microbiol., 9: 34-39 (2001); Briandet et al., Colloids Surf. B. Biointerfaces, 21: 299-310 (2001); Bollinger et al., J. Bacteriol., 183: 1990-1996 (2001)).

Biofilm-related infections are currently treated with antibiotics or antibiotic combinations that are optimized to treat infections caused by planktonic bacteria. The first line of antibiotics that are used to empirically treat a suspected staphylococcal biofilm infection include vancomycin or oxacillin (for methicillin-sensitive strains) administered intravenously. When an infected patient has been stabilized and the infectious agent and its antibiotic susceptibility have been identified, ciprofloxacin, trimethoprim-sulfamethoxazole, linezolid, or quinupristin-dalfopristin can be administered orally (Mermel et al., J. Intraven. Nurs., 24: 180-205 (2001). These treatments usually resolve the symptoms of infection by killing the planktonic bacteria released from the biofilm. However, despite the fact that antibiotics achieve therapeutic concentrations in the blood, only about 32% of infected catheters can be salvaged by antibiotic therapy (Saxena et al., Swiss Med. Wkly., 135: 127-138 (2005)). In the majority of cases, biofilm infections persist until the infected surface is removed. For cases in which the infected surface is a central venous catheter (CVC) inserted directly into the vein, the trauma caused by the removal of the device is minor. However, for catheters and medical devices that are surgically implanted, such as tunneled CVCs, artificial heart valves, and cardiac pacemakers, removal of the device can be extremely traumatic to the patient.

Following guidelines for the prevention of intravascular device-related infections such as those issued by the United States Center for Disease Control (Atlanta, Ga.) (O'Grady et al., Am. J. Infect. Control, 30: 476-489 (2002) has been shown in numerous studies to decrease the incidence of device-related infections, however, despite attempts to implement these measures, device-related infections remain a significant problem. In order to reduce the risk of biofilm infections, catheters impregnated with a biocide (chlorhexidine-silver sulfadiazine) and antibiotics (rifampin-minocycline) have been introduced into the market (Potera, Science, 283: 1837, 1839 (1999)). These devices have been shown to be effective in clinical trials, however the use of chlorhexidine-silver sulfadiazine-impregnated catheters in Japan has been associated with serious anaphylactic reactions (Oda et al., Anesthesiology, 87(5): 1242-1244 (1997); Terazawa et al., Anesthesiology, 89(5): 1296-1298 (1998)). A catheter impregnated with minocycline and rifampin was shown to be more susceptible to colonization when challenged with a rifampin-resistant S. epidermidis strain than a catheter impregnated with silver sulfadiazine and chlorhexidine (Sampath et al., Infect. Control Hosp. Epidemiol., 22: 640-646 (2001)). In certain cases, antibiotic lock therapy can be used to treat biofilm infections of catheters in which the lumen of the catheter is filled with an antibiotic solution at a high concentration in order to sterilize the device (Carratala, J. Clin. Microbiol. Infect., 8: 282-289 (2002). This procedure has been shown to be effective against biofilms in the catheter lumen.

Two compounds, in particular, have been the focus of recent studies to develop prophylactic therapies for biofilm formation. The first compound is a halogenated furanone (3-(1-bromohexyl)-5-(dibromomethylene)furan-2(5H)-one; (5Z)-4-bromo-5-(bromomethylene)-3-butyl-2(5H)-furanone) that is a derivative of a secondary metabolite of Delisea pulchra, an Australian macroalga. This compound interferes with AI-2 quorum sensing in several Gram-negative bacterial species and prevents formation of biofilms (Hentzer et al., Microbiol., 148: 87-102 (2002)). In addition, halogenated furanones have been reported to inhibit biofilm formation of Gram-positive bacterial species, such as S. epidermidis (Baveja et al., Biomaterials, 25: 5013-5021 (2004); Baveja et al., Biomaterials, 25: 5003-5012 (2004); Hume et al., Biomaterials, 25: 5023-5030 (2004)) and Bacillus subtilis (Ren et al., Appl. Environ. Microbiol., 70: 4941-4949 (2004)). The halogenated furanones appear to have the potential to provide a biofilm inhibitor with a broad spectrum of activity. However, it is likely that the observed biofilm-inhibiting activity against Gram-positive bacteria is due to an antibacterial activity (Ren et al., Appl. Environ. Microbiol., 70: 4941-4949 (2004)) and not to a specific inhibition of biofilm formation. In fact, deletion of the gene (luxS) required to synthesize AI-2 in S. epidermidis (Xu et al., Infect. Immun., 74: 488-496 (2006)) and S. aureus (Doherty et al., J. Bacteriol., 188: 2885-2897 (2006)) did not adversely affect biofilm formation, indicating the AI-2 signaling pathway is not required for biofilm formation in these bacterial species. Another compound under study is the cationic peptide RIP (Balaban et al., J. Infect. Dis., 187: 625-630 (2003); Balaban et al., Clin. Orthop. Relat. Res., 437: 48-54 (2005). RIP inhibits quorum sensing in staphylococci and interferes with biofilm formation and expression of virulence factors (Balaban et al. (2003), op. cit.; Balaban et al. (2005), op. cit.).

The few approved therapeutic compounds and procedures that are currently available to treat biofilm-based infections have not reversed the growing incidence of such diseases. The U.S. Center for Disease Control has estimated that organisms growing in a biofilm cause as much as 65% of the infections treated by physicians in the developed world (Costerton et al., Science, 284: 1318-1322 (1999)). In addition, approximately 10% of the 5 million CVCs and pulmonary arterial catheters (Swan-Ganz) placed in the United States per year become infected resulting in about 200,000 to 400,000 episodes of catheter-related bloodstream infections.

In view of the few compounds that are currently available to prevent or treat bacterial biofilm formation, the continuing use of implantable catheters and other devices, and the likelihood that strains of biofilm-forming bacterial pathogens will eventually emerge that are resistant to these compounds, needs clearly remain for new means and methods for inhibiting bacterial biofilm formation.

### SUMMARY OF THE INVENTION

The invention addresses the above problems by providing biofilm inhibitor compounds that are organic compounds that inhibit or prevent formation of bacterial biofilms. Such compounds are useful for inhibiting or preventing formation of bacterial biofilms by Gram-positive biofilm-forming bacteria, including, but not limited to, Staphylococcus epidermidis, Staphylococcus aureus, Enterococcus faecalis, and Enterococcus faecium, which have been associated with bacterial biofilm contamination in widely used indwelling medical devices. Biofilm inhibitor compounds described herein are particularly useful for inhibiting or preventing biofilm formation on surfaces that are susceptible to or are already in contact with bacterial cells that can form biofilms.

In one embodiment, the invention provides a biofilm inhibitor compound useful in the compositions and methods described herein, which compound has the structure of Formula 1:

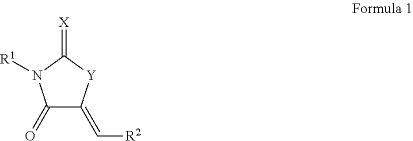

wherein

### X is S or O;

### Y is S or N;

### R¹ is:

a) a substituted phenyl group, wherein the phenyl group is substituted at one or more of positions 3, 4, and 5, with a radical selected from the group consisting of halo (fluoro, chloro, bromo, or iodo); cyano (—CN); carboxyl (—COOH); carboxylic acid ester groups, —COOR⁵, wherein R⁵ is alkyl; —CF₃ (trifluoromethyl); nitro (—NO₂); sulfonyl groups, —SO₂R⁶, wherein R⁶ is alkyl; sulfamoyl, —SO₂NH₂; aldehyde (—CHO); and ketone groups —C(O)R⁷, wherein R⁷ is alkyl; and wherein said phenyl group is not substituted at positions 2 and 6; or
b) a substituted heteroaryl group, wherein the heteroaryl group is pyridinyl, pyrazinyl, pyrimidinyl, or pyridazinyl, and wherein said heteroaryl group is substituted at one or more ring carbons with any of the group consisting of halo (fluoro, chloro, bromo, or iodo); cyano (—CN); carboxyl (—COOH); carboxylic acid ester groups, —COOR⁵, wherein R⁵ is alkyl; —CF₃ (trifluoromethyl); nitro (—NO₂); sulfonyl groups, —SO₂R⁶, wherein R⁶ is alkyl; sulfamoyl, —SO₂NH₂; aldehyde (—CHO); and ketone groups —C(O)R⁷, wherein R⁷ is alkyl;
   and

### R² is:

a substituted phenyl group, wherein the phenyl group is substituted with a radical at one or more positions selected from the group consisting of:
   a) substitution at position 4 with hydroxyl (—OH) or amino (—NH₂);
   b) substitution at position 3 with a radical selected from the group consisting of hydroxyl; alkoxy, alkyleneoxy, or alkylideneoxy groups, —OR⁸, wherein R⁸ is alkyl, alkenyl, or alkynyl; and amino and substituted amino groups, —NR⁹R¹⁰, wherein R⁹ and R¹⁰ are, independently, H, alkyl, alkenyl, or alkynyl; and
   c) substitution at position 5 with a radical selected from the group consisting of halo (fluoro, chloro, bromo, or iodo); alkyl; alkenyl; alkynyl; hydroxyl; alkoxy, alkyleneoxy, or alkylideneoxy radicals, —OR⁸, wherein R⁸ is alkyl, alkenyl, or alkynyl; cyano; amino and substituted amino groups, —NR⁹R¹⁰, wherein R⁹ and R¹⁰ are, independently, H, alkyl, alkenyl, or alkynyl; carboxyl and carboxylic acid ester groups, —COOR⁵, wherein R⁵ is H or alkyl; —CF₃ (trifluoromethyl); sulfonyl groups, —SO₂R⁶, wherein R⁶ is alkyl; —SO₂NH₂ (sulfamoyl); aldehyde (—CHO); and ketone groups, —C(O)R⁷, wherein R⁷ is alkyl;
and wherein the phenyl group has no substitutions at positions 2 and 6;
   and wherein the compound inhibits bacterial biofilm formation.

In a preferred embodiment, a biofilm inhibitor compound of Formula 1, above, is a rhodanine compound that has the structure of Formula 2:

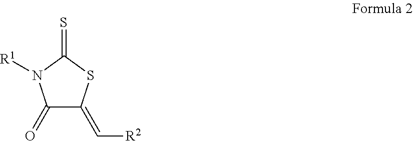

wherein R¹ and R² are as described above for Formula 1;
and wherein the compound inhibits bacterial biofilm formation.

Preferably, the rhodanine biofilm inhibitor compound of Formula 2 is selected from the group consisting of 3-(3-chlorophenyl)-5-(3-bromo-4-hydroxy-5-methoxy-benzylidene)-2-thioxothiazolidin-4-one (MSL-049731 in Table 2), 3-(4-bromophenyl)-5-(3-ethoxy-4-hydroxybenzylidene)-2-thioxothiazolidin-4-one (MSL-049293 in Table 2), 3-(4-chlorophenyl)-5-(3-chloro-5-ethoxy-4-hydroxybenzylidene)thiazolidine-2,4-dione (MSL-6519056 in Table 2), (Z)-3-(4-fluorophenyl)-5-(3-hydroxy-4-ethoxybenzylidene)-2-thioxothiazolidin-4-one (Compound 4 in Table 3), (Z)-3-(3-fluorophenyl)-5-(3-hydroxy-4-ethoxybenzylidene)-2-thioxothiazolidin-4-one (Compound 8 in Table 3), (Z)-3-(4-fluorophenyl)-5-(3-allyloxy-4-hydroxybenzylidene)-2-thioxothiazolidin-4-one (Compound 29 in Table 3), (Z)-3-(3-cyanophenyl)-5-(3-hydroxy-4-methoxybenzylidene)-2-thioxothiazolidin-4-one (Compound 34 in Table 3), (Z)-3-(pyridin-3-yl)-5-(3-hydroxy-4-methoxybenzylidene)-2-thioxothiazolidin-4-one (Compound 36 in Table 3), (Z)-3-(6-fluoropyridin-3-yl)-5-(3-hydroxy-4-methoxybenzylidene)-2-thioxothiazolidin-4-one (Compound 40 in Table 3), and (Z)-3-(4-methoxycarbonylphenyl)-5-(3-hydroxy-4-methoxybenzylidene)-2-thioxothiazolidin-4-one (Compound 49 in Table 3).

In another preferred embodiment, a biofilm inhibitor compound of Formula 1 is a thiazolidinedione compound that has the structure of Formula 3:

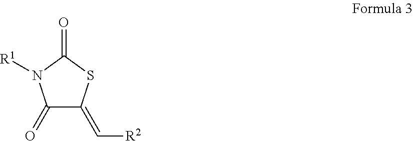

wherein R¹ and R² are as described above for Formula 1;
and wherein the compound inhibits bacterial biofilm formation.

Preferably, the thiazolidinedione biofilm inhibitor compound of Formula 3 is (Z)-3-(4-fluorophenyl)-5-(3-hydroxy-4-ethoxybenzylidene)thiazolidine-2,4-dione (Compound 60 in Table 3) or (Z)-3-(4-chlorophenyl)-5-(3-hydroxy-4-ethoxybenzylidene)thiazolidine-2,4-dione (Compound 61 in Table 3).

In yet another preferred embodiment, a biofilm inhibitor compound of Formula 1 is a hydantoin compound that has the structure of Formula 4:

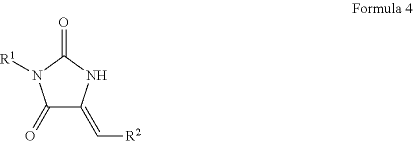

wherein R¹ and R² are as described above for Formula 1;
and wherein the compound inhibits bacterial biofilm formation.

Preferably, the hydantoin biofilm compound of Formula 4 is (Z)-3-(4-fluorophenyl)-5-(3-hydroxy-4-ethoxybenzylidene)imidazolidine-2,4-dione (Compound 58 in Table 3) or (Z)-3-(4-chlorophenyl)-5-(3-hydroxy-4-ethoxybenzylidene)imidazolidine-2,4-dione (Compound 59 in Table 3).

In still another embodiment, a biofilm inhibitor compound of Formula 1 is a thiohydantoin compound that has the structure of Formula 5:

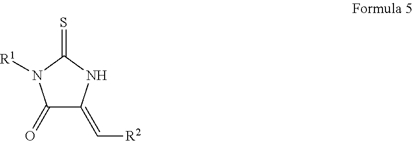

wherein R¹ and R² are as described above for Formula 1;
and wherein the compound inhibits bacterial biofilm formation.

A preferred thiohydantoin biofilm inhibitor compound of Formula 5 is (Z)-3-(4-fluorophenyl)-5-(3-hydroxy-4-ethoxybenzylidene)-2-thioxoimidazolidin-4-one (Compound 62 in Table 3).

In one embodiment of the invention, a biofilm inhibitor compound is a furanone compound that has the structure of Formula 6:

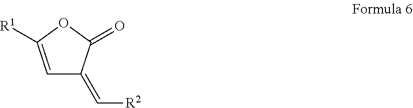

wherein R¹ and R² are as described above for Formula 1;
and wherein the compound inhibits bacterial biofilm formation.

A preferred furanone biofilm inhibitor compound of Formula 6 is 3-(4-hydroxy-3-methoxybenzylidene)-5-(2,4-dimethoxyphenyl)furan-2(3H)-one (MSL-051097 in Table 2).

In another preferred embodiment, a biofilm inhibitor compound described herein inhibits biofilm formation by one or more Gram-positive bacterial strains by at least 80% (≧80%) in a biofilm inhibition assay described herein.

In yet another preferred embodiment, a biofilm inhibitor compound described herein has an anti-biofilm activity indicated by a Minimal Biofilm Inhibitory Concentration (MBIC), as defined herein, of less than or equal to 25 μM (MBIC≦25 μM), more preferably less than or equal to 12.5 μM (MBIC≦12.5 μM), and even more preferably less than 10 μM (MBIC<10 μM).

Biofilm inhibitors described herein are particularly useful in preventing or inhibiting bacterial biofilm formation on a surface that may be exposed to or contaminated with biofilm-forming, Gram-positive bacteria. Such surfaces include, but are not limited to, surfaces of implantable medical devices (including, but not limited to, central venous catheters (CVCs), implantable pumps, artificial heart valve, and cardiac pacemakers); cardiopulmonary bypass (CPB) pumps (heart-lung machine); dialysis equipment; artificial respirators; breathing apparatuses (oxygen and air supplies); water pipes; plumbing fixtures; and air ducts. Thus, the present invention also provides a method for inhibiting bacterial biofilm formation on a surface comprising treating said surface with a compound of Formula 1, particularly a compound of any one of Formulae 2, 3, 4, 5 or 6. The biofilm inhibitor compound may be applied to the surface prior to its exposure or infection with a biofilm-forming bacterium, after biofilm-forming bacteria have contacted the surface, or after a bacterial biofilm has already formed on the surface. The anti-biofilm compounds disclosed herein may thus be advantageously employed to prevent biofilm formation on a surface or to arrest biofilm formation on a surface. Preferably, a biofilm inhibitor compound described herein is applied to a surface prior to the formation of a bacterial biofilm on the surface. More preferably, a biofilm inhibitor compound described herein is applied to or present on a surface before biofilm-forming bacteria contact the surface. See, e.g., FIG. 1.

A biofilm inhibitor described herein may be applied to a desired surface by any of a variety methods including, but not limited to, coating, impregnation, and covalent conjugation. A biofilm inhibitor described herein may also be employed in a lock solution (solution or suspension) to fill the lumen of a catheter or other medical device prior to use.

### BRIEF DESCRIPTION OF THE DRAWING

FIG. 1 shows inhibition of biofilm formation (biofilm growth) by cultures of Staphylococcus aureus ATCC 35556 treated with (Z)-3-(4-fluorophenyl)-5-(3-hydroxy-4-ethoxybenzylidene)-2-thioxothiazolidin-4-one (Compound 4) as described in Example 5. Compound 4 was added to bacterial cultures at a concentration of 4XMBIC (12 μM) at various times (0, 1, 2, 4, 6, 8, 10, 12, and 21 hours) over a 22 hour incubation period. Biofilm growth was also followed in parallel cultures in the absence of Compound 4 (untreated controls). Biofilm growth was quantified in samples by staining with crystal violet and measuring OD₆₀₀. Primary (left-hand) y-axis shows the percent inhibition of biofilm growth (% Inhibition Biofilm) in cultures treated with Compound 4 over time (x-axis). Secondary (right-hand) y-axis shows biofilm growth in parallel untreated control cultures. See, Example 5 for details.

### DETAILED DESCRIPTION OF THE INVENTION

In order that the invention may be more clearly understood, the following abbreviations and terms are used as defined below.

Unless indicated otherwise, when the terms “about” and “approximately” are used in combination with an amount, number, or value, then that combination describes the recited amount, number, or value alone as well as the amount, number, or value plus or minus 10% of that amount, number, or value. By way of example, the phrases “about 40%” and “approximately 40%” disclose both “40%” and “from 36% to 44%, inclusive”.

Abbreviations for substituent groups (radicals) attached to a position of an organic molecule are any of those commonly used in organic chemistry. Such abbreviations may include “shorthand” forms of such substituent groups. For example, “Ac” is an abbreviation for an acetyl group, “Ar” is an abbreviation for an “aryl” group. “Bn” indicates benzyl. “Halo” or “halogen” indicates a halogen radical (F, Cl, Br, I). “Me”, “Et”, and “Pr” are abbreviations used to indicate methyl (CH₃—), ethyl (CH₃CH₂—), and propyl (CH₃CH₂CH₂—) groups, respectively; and “OMe” (or “MeO”) and “OEt” (or “EtO”) indicate methoxy (CH₃O—) and ethoxy (CH₃CH₂O—), respectively. “iPr” indicates isopropyl. “NCO” is an abbreviation for isocyanate, and “NCS” is an abbreviation for isothiocyanate. Hydrogen and carbon atoms are not always shown in the formulae for structures of organic molecules described herein or may be only selectively shown in some structures, as the presence and location of hydrogen and carbon atoms in the structural diagrams of organic molecules described herein are known and understood by persons skilled in the art.

The term “acyl” has the usual meaning known in the art. Preferably, “acyl” is the radical “—C(O)R”, wherein “—C(O)” indicates a carbonyl group and R is an aliphatic or aryl group or as otherwise specified herein.

The term “alkyl” has the usual meaning known in the art and means a saturated hydrocarbon chain that may be a straight or branched hydrocarbon chain radical. Preferably, an alkyl group is a C₁-C₁₈ saturated hydrocarbon chain, more preferably a C₁-C₁₀ saturated hydrocarbon chain, even more preferably a C₁-C₆ saturated hydrocarbon chain, and still more preferably a C₁-C₄ saturated hydrocarbon chain. Alkyl radicals include, but are not limited to, methyl, ethyl, propyl, butyl, pentyl, hexyl, isopropyl, isobutyl, sec-butyl, t-butyl, isopentyl, amyl, and t-pentyl. Unless specified otherwise, a “substituted alkyl” group is an alkyl group substituted with one or more conventionally used substituent groups, such as, amino, alkylamino (CₙH₂ₙ₊₁—NH—), alkoxy, alkylthio, oxo, halo, acyl, nitro, hydroxyl, cyano, aryl, alkylaryl, aryloxy, arylthio, arylamino (ArNH—), carbocyclyl, carbocyclyloxy, carbocyclylthio, carbocyclylamino, heterocyclyl, heterocyclyloxy, heterocyclylamino, heterocyclylthio, and the like. Unless otherwise specified, when the term “alkyl” is used together in a compound term, such as “carbocyclylalkyl” or “arylalkyl”, the number of carbon atoms or ring numbers used in connection with such compound term shall not include the atoms of the alkyl portion of the moiety (unless the other portion of the moiety does not contain any carbon atoms). In such cases, the alkyl portion will typically have the chain length set forth in the definition above for other alkyl moieties.

The term “heteroalkyl” shall mean an alkyl radical as defined above in which a carbon atom in the alkyl moiety is replaced with oxygen (O), sulfur (S), or nitrogen (N).

The term “alkylamino” means an amino radical substituted with one or two alkyl groups (i.e., includes dialkyl amino radicals) wherein the alkyl groups may be the same or different.

The term “aralkyl” means an aryl radical substituted with one or more alkyl substituents groups.

The term “alkenyl” means an aliphatic, straight or branched chain hydrocarbon radical having one or more carbon-carbon double bond. Alkenyl groups containing three or more carbon atoms may be straight or branched. Preferably, an alkenyl group is a C₂-C₁₈ hydrocarbon chain, more preferably a C₂-C₁₀ hydrocarbon chain, even more preferably a C₂-C₆ hydrocarbon chain, and still more preferably a C₂-C₄ saturated hydrocarbon chain. Suitable alkenyl radicals include, but are not limited to, vinyl, allyl (2-propenyl), isopropenyl, 2-butenyl, 1,3-butadienyl, 2-pentenyl, 1,3-pentadienyl, and the like.

The term “alkynyl” means an aliphatic hydrocarbon radical having one or more carbon-carbon triple bond. Alkynyl groups containing three or more carbon atoms may be straight or branched. Preferably, an alkynyl group is a C₂-C₁₈ hydrocarbon chain, more preferably a C₂-C₁₀ hydrocarbon chain, even more preferably a C₂-C₆ hydrocarbon chain, and still more preferably C₂-C₄ hydrocarbon chain.

The term “aryl” means a monovalent cyclic hydrocarbon radical having a 5-8 membered monocyclic aromatic ring or a polycyclic aromatic ring system having 5-8 ring members in each ring thereof. Aryl radicals may be unsubstituted or substituted with one or more substituents selected from, but not limited to, alkyl (e.g., “lower” or C₁-C₆ alkyl), hydroxy, alkoxy (e.g., lower alkoxy), alkylthio, cyano, halo, amino, and nitro. Examples of aryl groups include, but are not limited to, phenyl, methylphenyl (tolyl), dimethylphenyl, aminophenyl, nitrophenyl, hydroxyphenyl, and naphthyl (e.g., 1-naphtyl, 2-naphthyl).

“Heteroaryl” means an aryl radical, as described above, wherein one or more ring carbon atoms is replaced with nitrogen (N), oxygen (O), or sulfur (S). Preferred heteroaryl radicals include a phenyl group in which one or two ring carbons is replaced with nitrogen (N). More preferably, a heteroaryl radical useful in the compounds described herein is pyrrolyl, pyridyl, pyridinyl, pyrazinyl, pyrimidinyl, pyridazinyl, thiazolyl, and oxazolyl.

“Heterocyclyl” means a heterocyclic radical containing one or more rings which may be saturated, unsaturated, or aromatic (i.e., heteroaryl) wherein at least one ring of the radical contains one or more heteroatoms selected from nitrogen (N), oxygen (O), and sulfur (S). In addition, heterocyclyl radicals may contain one or more substituent groups, i.e., a ring substituent (for example, a halo radical, an alkyl radical, or aryl radical) attached to a ring member atom of the heterocyclyl radical. All stable isomers of heterocyclyl groups are contemplated in this definition.

“Lower” when used in the context of organic chemistry as applied to a linear molecular group (radical) means the group to which it is applied has 1-6 atoms, i.e., no more than six member atoms, except in the case of rings (such as cycloalkyl), in which case “lower” signifies rings that have 3-6 member atoms. By way of non-limiting example, a “lower” alkyl is a C₁-C₆ chain such as methyl, ethyl, propyl, butyl, pentyl, or hexyl. A more preferred lower alkyl is a C₁-C₄ chain. Also by way of non-limiting example, owing to the presence of a double bond, a “lower” alkenyl is a C₂-C₆ group such as ethenyl propenyl, butenyl, pentenyl, or hexenyl. A more preferred lower alkenyl is a C₂-C₄ chain. Also by way of non-limiting example, owing to the presence of a triple bond, a “lower” alkynyl is a C₂-C₆ group such as acetylenyl, propynyl, butynyl, pentynyl, or hexynyl. A more preferred lower alkynyl is a C₂-C₄ chain.

A composition or method described herein as “comprising” one or more named elements or steps is open-ended, meaning that the named elements or steps are essential, but other elements or steps may be added within the scope of the composition or method. To avoid prolixity, it is also understood that any composition or method described as “comprising” (or which “comprises”) one or more named elements or steps also describes the corresponding, more limited composition or method “consisting essentially of” (or which “consists essentially of”) the same named elements or steps, meaning that the composition or method includes the named essential elements or steps and may also include additional elements or steps that do not materially affect the basic and novel characteristic(s) of the composition or method. It is also understood that any composition or method described herein as “comprising” or “consisting essentially of” one or more named elements or steps also describes the corresponding, more limited, and closed-ended composition or method “consisting of” (or “consists of”) the named elements or steps to the exclusion of any other unnamed element or step. In any composition or method disclosed herein, known or disclosed equivalents of any named essential element or step may be substituted for that element or step.

It is also understood that an element or step “selected from the group consisting of” or otherwise recited in a list of elements or steps refers to one or more of the elements or steps in the list that follows, including combinations of any two or more of the listed elements or steps, unless otherwise stated.

The meaning of other terms will be understood by the context as understood by the skilled practitioner in the art, including the fields of organic chemistry, pharmacology, pharmaceutics, and microbiology.

The invention is based on the discovery that certain heterocyclyl compounds inhibit bacterial biofilm formation by Gram-positive bacteria, including one or more strains of Staphylococcus epidermidis, S. aureus, Enterococcus faecalis, and Enterococcus faecium, which have been associated with bacterial biofilm contamination in widely used indwelling medical devices. Such compounds are referred to as “biofilm inhibitor compounds”, “biofilm inhibitors”, or “anti-biofilm compounds”.

Biofilm inhibitors as described herein were initially discovered from running a high throughput, cell-based screening of multiple libraries providing over 87,000 organic molecules (see, Table 1, Example 1, infra) to identify compounds (“hits”) that inhibited biofilm formation by Staphylococcus epidermidis, but that also had a minimal effect on planktonic growth (see, Table 2, Example 2, infra). The Minimal Biofilm Inhibition Concentration (MBIC), as used herein, refers to the lowest concentration of a compound that inhibits biofilm formation by greater than or equal to 80% (≧80%). The Minimal Inhibitory Concentration (MIC), as used herein, refers to the lowest concentration of a compound that inhibits bacterial growth by greater than or equal to 80% (≧80%). For cytotoxicity, “CC₅₀” refers to the concentration of a compound that reduces viability of a mammalian cell line (e.g., HeLa cells) by 50%. From the initial library screening protocol, 145 confirmed hits (0.16%) were identified that met the following criteria: MBIC≦12.5 μM and MIC≧100 μM. These compounds were designated as validated hits based on anti-biofilm (inhibition of biofilm formation) and anti-bacterial activity data. Cytotoxicity data (CC₅₀) using HeLa human cell line were used to prioritize the validated hits. Validated hits with CC₅₀/MBIC>8 were given highest priority.

The confirmed biofilm inhibitors from the library screenings were evaluated in a series of secondary assays to assess their anti-biofilm activity against S. epidermidis, S. aureus, and Enterococcus faecalis, as well as cytotoxicity against a human (HeLa) cell line to obtain compounds that inhibited biofilm production by one or more strains of the Gram-positive bacterial species.

The initial discovery of validated biofilm inhibitors from the library screenings led to the discovery of additional compounds that inhibit bacterial biofilm formation by one or more Gram-positive bacterial strains. A preferred biofilm inhibitor described herein has an MBIC of less than or equal to 25 μM for one or more strains of S. epidermidis, S. aureus, E. faecalis, E. faecium, and Enterococcus gallinarum.

A biofilm inhibitor useful in compositions and methods described herein for inhibiting or preventing bacterial biofilm formation on a surface is a compound that has the structure of Formula 1:

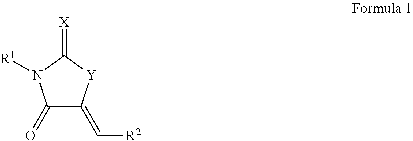

wherein

### X is S or O;

### Y is S or N;

### R¹ is:

a) a substituted phenyl group, wherein the phenyl group is substituted at one or more of positions 3, 4, and 5, with a radical selected from the group consisting of halo (fluoro, chloro, bromo, or iodo); cyano (—CN); carboxyl (—COOH); carboxylic acid ester groups, —COOR⁵, wherein R⁵ is alkyl; —CF₃ (trifluoromethyl); nitro (—NO₂); sulfonyl groups, —SO₂R⁶, wherein R⁶ is alkyl; sulfamoyl, —SO₂NH₂; aldehyde (—CHO); and ketone groups —C(O)R⁷, wherein R⁷ is alkyl; and wherein said phenyl group is not substituted at positions 2 and 6; or
b) a substituted heteroaryl group, wherein the heteroaryl group is pyridinyl, pyrazinyl, pyrimidinyl, or pyridazinyl, and wherein said heteroaryl group is substituted at one or more ring carbons with any of the group consisting of halo (fluoro, chloro, bromo, or iodo); cyano (—CN); carboxyl (—COOH); carboxylic acid ester groups, —COOR⁵, wherein R⁵ is alkyl; —CF₃ (trifluoromethyl); nitro (—NO₂); sulfonyl groups, —SO₂R⁶, wherein R⁶ is alkyl; sulfamoyl, —SO₂NH₂; aldehyde (—CHO); and ketone groups —C(O)R⁷, wherein R⁷ is alkyl;
   and

### R² is:

a substituted phenyl group, wherein the phenyl group is substituted with a radical at one or more positions selected from the group consisting of:
   a) substitution at position 4 with hydroxyl (—OH) or amino (—NH₂);
   b) substitution at position 3 with a radical selected from the group consisting of hydroxyl; alkoxy, alkyleneoxy, or alkylideneoxy groups, —OR⁸, wherein R⁸ is alkyl, alkenyl, or alkynyl; and amino and substituted amino groups, —NR⁹R¹⁰, wherein R⁹ and R¹⁰ are, independently, H, alkyl, alkenyl, or alkynyl; and
   c) substitution at position 5 with a radical selected from the group consisting of halo (fluoro, chloro, bromo, or iodo); alkyl; alkenyl; alkynyl; hydroxyl; alkoxy, alkyleneoxy, or alkylideneoxy radicals, —OR⁸, wherein R⁸ is alkyl, alkenyl, or alkynyl; cyano; amino and substituted amino groups, —NR⁹R¹⁰, wherein R⁹ and R¹⁰ are, independently, H, alkyl, alkenyl, or alkynyl; carboxyl and carboxylic acid ester groups, —COOR⁵, wherein R⁵ is H or alkyl; —CF₃ (trifluoromethyl); sulfonyl groups, —SO₂R⁶, wherein R⁶ is alkyl; —SO₂NH₂ (sulfamoyl); aldehyde (—CHO); and ketone groups, —C(O)R⁷, wherein R⁷ is alkyl;
and wherein the phenyl group has no substitutions at positions 2 and 6;
   and wherein the compound inhibits bacterial biofilm formation.

A biofilm inhibitor of Formula 1, above, may be a rhodanine compound that has the structure of Formula 2:

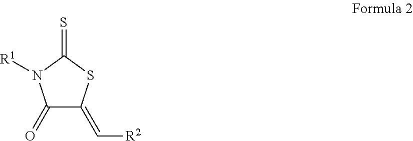

wherein R¹ and R² are as described above for Formula 1;
and wherein the compound inhibits bacterial biofilm formation.

A preferred rhodanine biofilm inhibitor compound of Formula 2 useful in compositions and methods described herein is selected from the group consisting of is 3-(3-chlorophenyl)-5-(3-bromo-4-hydroxy-5-methoxy-benzylidene)-2-thioxothiazolidin-4-one (MSL-049731 in Table 2), 3-(4-bromophenyl)-5-(3-ethoxy-4-hydroxybenzylidene)-2-thioxothiazolidin-4-one (MSL-049293 in Table 2), 3-(4-chlorophenyl)-5-(3-chloro-5-ethoxy-4-hydroxybenzylidene)thiazolidine-2,4-dione (MSL-6519056 in Table 2), (Z)-3-(4-fluorophenyl)-5-(3-hydroxy-4-ethoxybenzylidene)-2-thioxothiazolidin-4-one (Compound 4 in Table 3), (Z)-3-(3-fluorophenyl)-5-(3-hydroxy-4-ethoxybenzylidene)-2-thioxothiazolidin-4-one (Compound 8 in Table 3), (Z)-3-(4-fluorophenyl)-5-(3-allyloxy-4-hydroxybenzylidene)-2-thioxothiazolidin-4-one (Compound 29 in Table 3), (Z)-3-(3-cyanophenyl)-5-(3-hydroxy-4-methoxybenzylidene)-2-thioxothiazolidin-4-one (Compound 34 in Table 3), (Z)-3-(pyridin-3-yl)-5-(3-hydroxy-4-methoxybenzylidene)-2-thioxothiazolidin-4-one (Compound 36 in Table 3), (Z)-3-(6-fluoropyridin-3-yl)-5-(3-hydroxy-4-methoxybenzylidene)-2-thioxothiazolidin-4-one (Compound 40 in Table 3), and (Z)-3-(4-methoxycarbonylphenyl)-5-(3-hydroxy-4-methoxybenzylidene)-2-thioxothiazolidin-4-one (Compound 49 in Table 3).

In another preferred embodiment, a biofilm inhibitor of Formula 1 is a thiazolidinedione compound that has the structure of Formula 3:

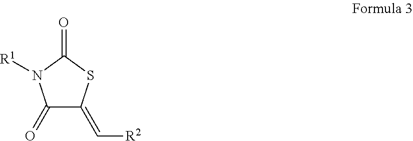

wherein R¹ and R² are as described above for Formula 1;
and wherein the compound inhibits bacterial biofilm formation.

A preferred thiazolidinedione biofilm inhibitor compound of Formula 3 useful in compositions and methods described herein is (Z)-3-(4-fluorophenyl)-5-(3-hydroxy-4-ethoxybenzylidene)thiazolidine-2,4-dione (Compound 60 in Table 3) or (Z)-3-(4-chlorophenyl)-5-(3-hydroxy-4-ethoxybenzylidene)thiazolidine-2,4-dione (Compound 61 in Table 3).

A biofilm inhibitor of Formula 1 may be a hydantoin compound that has the structure of Formula 4:

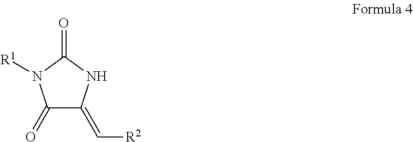

wherein R¹ and R² are as described above for Formula 1;
and wherein the compound inhibits bacterial biofilm formation.

A preferred hydantoin biofilm inhibitor compound of Formula 4 useful in compositions and methods described herein is (Z)-3-(4-fluorophenyl)-5-(3-hydroxy-4-ethoxybenzylidene)imidazolidine-2,4-dione (Compound 58 in Table 3) or (Z)-3-(4-chlorophenyl)-5-(3-hydroxy-4-ethoxybenzylidene)imidazolidine-2,4-dione (Compound 59 in Table 3).

A biofilm inhibitor of Formula 1 may be a thiohydantoin compound that has the structure of Formula 5:

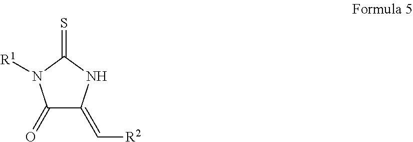

wherein R¹ and R² are as described above for Formula 1;
and wherein the compound inhibits bacterial biofilm formation.

A preferred thiohydantoin biofilm inhibitor compound of Formula 5 useful in compositions and methods described herein is (Z)-3-(4-fluorophenyl)-5-(3-hydroxy-4-ethoxybenzylidene)-2-thioxoimidazolidin-4-one (Compound 62 in Table 3).

Another biofilm inhibitor useful in the compositions and methods described herein for inhibiting bacterial biofilm formation is a furanone compound that has the structure of Formula 6:

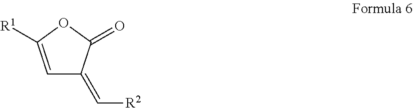

wherein R¹ and R² are as described above for Formula 1;
and wherein the compound inhibits bacterial biofilm formation.

A preferred furanone biofilm inhibitor of Formula 6 useful in compositions and methods described herein is 3-(4-hydroxy-3-methoxybenzylidene)-5-(2,4-dimethoxyphenyl)furan-2(3H)-one (MSL-051097 in Table 2).

### Synthesis of Bacterial Biofilm Inhibitors

Bacterial biofilm inhibitor compounds described herein may be synthesized using methods known in the art. As shown below, the preferred two-step synthetic schemes for the biofilm inhibitors of FIGS. 2-6, above, involve a common second-step condensation of a 3-substituted core ring structure with an aldehyde to form the desired biofilm inhibitor product. The condensation of a core ring structure with an aldehyde to yield a desired product is a well known reaction and readily adapted to the synthesis of the biofilm inhibitors described herein. See, e.g., Whitesitt et al., Bioorg. Med. Chem. Lett., 6: 2157-2162 (1996); Grant et al., Bioorg. Med. Chem. Lett., 10: 2179-2182 (2000) (rhodanines); Mustafa et al., J. Am. Chem. Soc., 82: 2597-2602 (1960); Tanaka et al., J. Antibiotics, 47: 297-300 (1994).

### A. Synthesis of Rhodanine Biofilm Inhibitors.

The synthesis of rhodanine compounds from isothiocyanates has previously been described. See, e.g., Cutshall et al., Bioorg. Med. Chem. Lett., 15: 3374-3379 (2005); Sing et al., Bioorg. Med. Chem. Lett., 11: 91-94 (2001). Such methods may be adapted to synthesize rhodanine biofilm inhibitors described herein (Formula 2, above) according to the following synthetic scheme:

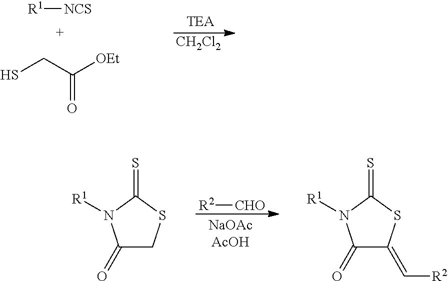

Rhodanine biofilm inhibitors with substituent groups at the 3- and 5-positions (R¹ and R², respectively) are constructed in a two-step procedure from the relevant isothiocyanates and aldehydes. In the first step, an isothiocyanate (R¹—NCS) is treated with ethyl thioglycolate in the presence of triethylamine in methylene chloride to produce a 3-substituted rhodanine. The resultant 3-substituted rhodanine is purified and then condensed with an aldehyde (R²—CHO) in the presence of sodium acetate and acetic acid to form the desired 3,5-disubstituted rhodanine.

Variations in R¹ are achieved through the selection of the corresponding isothiocyanate. The isothiocyanate may be obtained from commercial sources or by synthesis from the corresponding amine using procedures known in the art. See, e.g., Pascal et al., Eur. J. Med. Chem., 25: 81-85 (1990); Goodyer et al., Bioorg. Med. Chem., 11: 4189-4206 (2003). Variations in R² are achieved through incorporation of the corresponding aldehyde. The aldehyde may be purchased from commercial sources or synthesized using procedures known in the art. Substituent groups are generally not modified once they are incorporated into the structure, nor are additional substituent groups generally added or removed once the final structures are produced. All variations are generally achieved at the isothiocyanate and aldehyde level.

### B. Synthesis of Thiohydantoin Biofilm Inhibitors.

The synthesis of thiohydantoins from isothiocyanates has previously been described. See, e.g., El-Barbary et al., J. Med. Chem., 37: 73-77 (1994); Khodair, J. Carbohydr. Res., 331: 445-454 (2001). Such methods may be adapted to synthesize thiohydantoin biofilm inhibitors described herein (Formula 5, above) according to the following synthetic scheme:

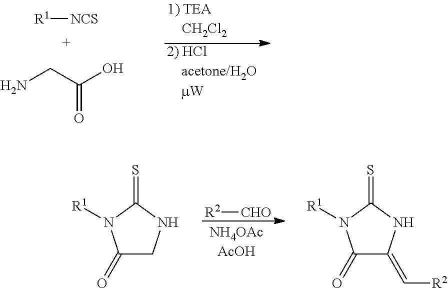

Thiohydantoins with substituent groups at the 3- and 5-positions (R¹ and R², respectively) are constructed in a two-step procedure from the relevant isothiocyanates and aldehydes. In the first step, an isothiocyanate (R¹—NCS) is treated with glycine in the presence of triethylamine in methylene chloride and then cyclized under acidic conditions to produce a 3-substituted thiohydantoin. The resultant 3-substituted thiohydantoin is purified and then condensed with an aldehyde (R²—CHO) in the presence of ammonium acetate and acetic acid to form the desired 3,5-disubstituted thiohydantoin.

Variations in R¹ are achieved through the selection of the corresponding isothiocyanate. The isothiocyanate may be obtained from commercial sources or by synthesis from the corresponding amine using procedures known in the art. See, e.g., Pascal et al., Eur. J. Med. Chem., 25: 81-85 (1990); Goodyer et al., Bioorg. Med. Chem., 11: 4189-4206 (2003). Variations in R² are achieved through incorporation of the corresponding aldehyde. The aldehyde may be purchased from commercial sources or synthesized using procedures known in the art. Substituent groups are generally not modified once they are incorporated into the structure, nor are additional substituent groups generally added or removed once the final structures are produced. All variations are generally achieved at the isothiocyanate and aldehyde level.

### C. Synthesis of Hydantoin Biofilm Inhibitors.

The synthesis of hydantoin compounds from isocyanates has previously been described. See, e.g., Boeijen et al., Bioorg. Med. Chem. Lett., 8: 2375-2380 (1998). Such methods may be adapted to synthesize hydantoin biofilm inhibitors described herein (Formula 4, above) according to the following synthetic scheme:

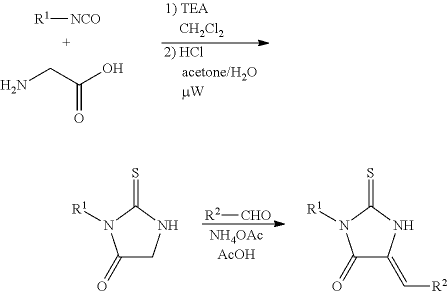

Hydantoins with substituent groups at the 3- and 5-positions (R¹ and R², respectively) are constructed in a two-step procedure from the relevant isocyanates and aldehydes. In the first step, an isocyanate (R¹—NCO) is treated with glycine in the presence of triethylamine in methylene chloride and then cyclized under acidic conditions to produce a 3-substituted hydantoin. The resultant 3-substituted hydantoin is purified, and then condensed with an aldehyde in the presence of ammonium acetate and acetic acid to form the desired 3,5-disubstituted hydantoin.

Variations in R¹ are achieved through the selection of isocyanate. The isocyanate is further derived from commercial sources or by synthesis from the corresponding amine using procedures known in the art. Variations in R² are achieved through incorporation of the corresponding aldehyde. The aldehyde may be purchased from commercial sources or synthesized using procedures known in the art. Substituent groups are generally not modified once they are incorporated into the structure, nor are additional substituent groups generally added or removed once the final structures are produced. All variations are generally achieved at the isothiocyanate and aldehyde level.

### D. Synthesis of Thiazolidinedione Biofilm Inhibitors.

Synthesis of thiazolidinedione by condensation of a core structure with an aldehyde has previously been described. See, e.g., Mustafa et al., J. Am. Chem. Soc., 82: 2597-2602 (1960). Such methods may be adapted to synthesize thiazolidinedione biofilm inhibitors as described herein (Formula 3, above) according to the following synthetic scheme:

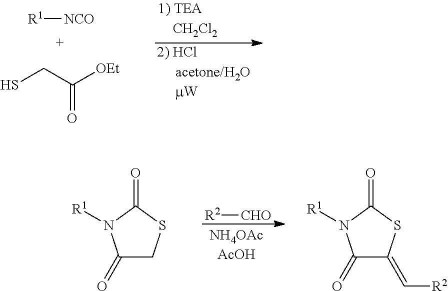

Thiazolidinediones with substituent groups at the 3- and 5-positions (R¹ and R², respectively) are constructed in a two-step procedure from the relevant isocyanates and aldehydes. In the first step, an isocyanate (R¹—NCO) is treated with ethyl thioglycolate in the presence of triethylamine in methylene chloride and then cyclized under acidic conditions to produce a 3-substituted thiazolidinedione. The resultant 3-substituted thiazolidinedione is purified and then condensed with an aldehyde in the presence of ammonium acetate and acetic acid to form the desired 3,5-disubstituted thiazolidinedione.

Variations in R¹ are achieved through the selection of isocyanate. The isocyanate may be derived from commercial sources or by synthesis from the corresponding amine using procedures known in the art. Variations in R² are achieved through incorporation of the corresponding aldehyde. The aldehyde may be purchased from commercial sources or synthesized using procedures known in the art. Substituent groups are generally not modified once they are incorporated into the structure, nor are additional substituent groups generally added or removed once the final structures are produced. All variations are generally achieved at the isothiocyanate and aldehyde level.

### E. Synthesis of Furanone Biofilm Inhibitors.

Methods for synthesizing furanones are well known in the art. See, e.g., Agnihotri et al., J. Indian Chem. Soc., 59: 869-876 (1982). Furanone biofilm inhibitors described herein (FIG. 6, above) may be synthesized according to the following synthetic scheme:

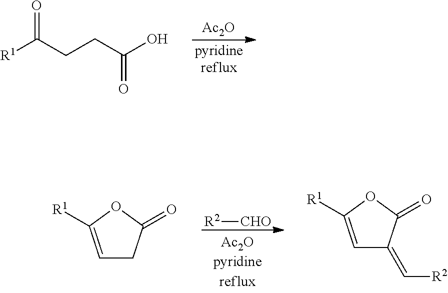

Furanones with substituent groups at the 3- and 5-positions (R² and R¹, respectively) are constructed in a two-step procedure from the relevant 4-R¹,4-oxobutanoic acids and aldehydes (R²—CHO). In the first step, a 4-oxobutanoic acid is treated with acetic anhydride and pyridine to produce a 5-substituted furanone. The resultant 5-substituted furanone is purified and then condensed with an aldehyde in the presence of acetic anhydride and pyridine to form the desired 3,5-disubstituted hydantoin. Alternatively, the 3,5-disubstituted furanone may be formed in a one-pot procedure by combining the 4-oxobutanoic acid and aldehyde in the presence of acetic anhydride and pyridine without isolating the intermediate mono-substituted furanone.

Variations in R¹ are achieved through the selection of 4-oxobutanoic acid. The 4-oxobutanoic acid may be obtained from commercial sources or by synthesis from the corresponding substituted benzene and succinic anhydride or via other routes using procedures known in the art. Variations in R² are achieved through incorporation of the corresponding aldehyde. The aldehyde may be purchased from commercial sources or synthesized using procedures known in the art. Substituent groups are generally not modified once they are incorporated into the structure, nor are additional substituent groups generally added or removed once the final structures are produced. All variations are generally achieved at the isothiocyanate and aldehyde level.

### Assays for Inhibition of Biofilm Formation (Anti-Biofilm Activity)

Assays for detecting and measuring bacterial biofilm formation are known in the art. An example of a biofilm formation assay useful in detecting and characterizing biofilm inhibitor compounds is described in Example 1, infra. Briefly, bacterial cells are inoculated into growth medium in individual wells of a 96-well assay plate in the presence or absence of a compound (known biofilm inhibitor or test compound). After incubation for a specified time, growth medium and non-biofilm bacterial cells are removed from each of the wells. The bacterial cells in any biofilms that are adhered to the surface of a well are fixed by addition of ethanol. The ethanol is removed, and the fixed biofilm bacteria cells are stained with crystal violet (CV). The intensity of CV staining is directly correlated with bacterial biofilm formation and is measured in the wells by reading the optical density at 600 nm (OD₆₀₀). The difference in biofilm formation between untreated control and treated cultures provides an indication of relative biofilm inhibition activity (anti-biofilm activity). Use of different concentrations of an inhibitor in multiple and otherwise duplicate cultures permits determination of a compound's Minimal Biofilm Inhibitory Concentration (MBIC), which is defined herein as the lowest concentration of a compound that inhibits biofilm formation by at least 80% (i.e., ≧80%) compared to untreated control cultures.

### Uses and Compositions of Bacterial Biofilm Inhibitors

The compounds described herein are referred to as “biofilm inhibitor compounds”, “biofilm inhibitors”, or “anti-biofilm compounds” owing to the fact that these compounds possess an activity (also referred to as an “anti-biofilm activity”) that inhibits or prevents biofilm formation by one or more species or strains of Gram-positive bacteria that are capable of forming biofilms. Such bacteria include, but are not limited to, Staphylococcus epidermidis, Staphylococcus aureus, and Enterococcus faecalis. Strains of one or more of such biofilm-forming Gram-positive bacteria have been documented to form biofilms on surfaces of implantable medical devices.

In a method according to the invention, inhibition or prevention of biofilm formation on surface comprises bringing a biofilm inhibitor described herein into contact with bacterial cells that are capable of forming a biofilm on a surface. Preferably, a biofilm inhibitor described herein is in contact with a surface prior to contact with biofilm-forming bacteria, however, a biofilm inhibitor may also be brought into contact with a surface that already contacts bacterial cells that are forming or capable of forming biofilms. A biofilm inhibitor compound is generally more effective in inhibiting biofilm formation on a surface if the compound is brought into contact with a surface prior to the surface being contacted with biofilm-forming bacterial cells or prior to establishment of a biofilm by cells already in contact with the surface.

A biofilm inhibitor compound described herein may be brought into contact with a solid surface composed of or comprising any of a variety of materials that support bacterial biofilm formation. Such materials include, but are not limited to, plastic, glass, silicon, metal, nylon, cellulose, nylon, polymeric resin, and combinations thereof.

While in theory a biofilm inhibitor compound described herein may be applied to a solid surface as the isolated compound alone (raw compound), it is more likely that the compound will be employed in a composition with at least one other compound. Compositions of the invention may be in any of a variety of forms particularly suited for the intended mode of applying a biofilm inhibitor compound to a solid surface. A carrier is any compound that provides a medium for using the biofilm inhibitor compound. A carrier may be liquid, solid, or semi-solid. A carrier for use in the compositions described herein includes, but is not limited to, water, an aqueous buffer, an organic solvent, and a solid dispersing agent. For solid compositions, conventional nontoxic solid carriers are preferred and include, but are not limited to, mannitol, lactose, starch, magnesium stearate, sodium saccharin, talc, cellulose, glucose, sucrose, magnesium carbonate, and the like. Liquid compositions may, for example, be prepared by dissolving or dispersing a biofilm inhibitor compound as described herein in a liquid carrier to form a solution or suspension.

A composition will include, as noted above, an effective amount of the selected biofilm inhibitor compound in combination with an acceptable carrier, and, optionally, may include one or more other agents, diluents, fillers, and excipients. An excipient is a compound that provides a desirable property to a composition other than inhibition of biofilm formation. An excipient useful in a composition described herein includes, but is not limited, a wetting agent, an emulsifying agent, pH buffering agent, a dispersing agent, co-solvent, surfactant, a gelling agent, and a drying agent.

A biofilm inhibitor described herein may be incorporated into any of a variety of compositions to provide the benefit of bacterial biofilm inhibition to the particular composition or to a surface to which the composition may be applied. Compositions comprising a biofilm inhibitor described herein include, but are not limited to, solutions, suspensions, dry mixtures, gels, petroleum products, porous membranes, porous filters, liposomes, resin particles, plastics, paints, glues, pastes, cellulose products, textiles (fiber, yarn, or cloth), and nanoparticles. A biofilm inhibitor may also be formulated by standard methods for delivery to a surface in an aerosol of fine solid particles or liquid droplets mixed with a gas. A composition described herein may optionally comprise an antibacterial growth agent (e.g., citrate, EDTA, antibiotic, or other microbial biocide) at a concentration effective to inhibit growth of or kill one or more strains of potentially contaminating bacteria that may contact the composition.

A biofilm inhibitor described herein may be applied to, coated on, impregnated, or otherwise incorporated into a surface that is susceptible to contact with Gram-positive bacteria that form biofilms. Such surfaces are found on a variety of manufactured products including, but not limited to, implantable medical devices (such as central venous catheters (CVCs), implantable pumps, artificial heart valves, and cardiac pacemakers); cardio-pulmonary bypass (CPB) pumps (heart-lung machines); dialysis equipment; artificial respirators; breathing apparatuses (oxygen and air supplies); water pipes; air ducts, air filters, water filters, and plumbing fixtures. The particular composition and properties of a particular surface will determine the preferred method by which the surface is treated to contain a biofilm inhibitor described herein.

Implantable medical devices that have surfaces that may be treated with a biofilm inhibitor described herein include, but are not limited to, central venous catheters (CVCs), implantable pumps, artificial heart valves, and cardiac pacemakers. The surfaces of a medical device may be coated with a biofilm inhibitor in a manner that is dependent on the specific chemical structure of the biofilm inhibitor compound and the type of material of which the device is constructed (reviewed by Zilberman and Elsner, Journal of Controlled Release, 130: 202-215 (2008)). To treat plastic surfaces of a device, a biofilm inhibitor described herein may be incorporated into a resin prior to polymerization, or the device or plastic component thereof may be immersed in a solution or suspension of a biofilm inhibitor preferably in the presence of one or more swelling agents to adsorb or absorb the biofilm inhibitor to the plastic surface (see, e.g., Schierholz et al., Biomaterials, 18: 839-844 (1997); Schierholz and Pulverer, Biomaterials, 19: 2065-2074 (1998); Schierholz et al., J. Antimicrob. Chemother., 46: 45-50 (2000)). A biofilm inhibitor may also be covalently bound to plastic using an appropriate cross-linking agent. Alternatively, a biofilm inhibitor may be impregnated into a material, such as a hydrogel or polymer, which would then be used to coat a medical device. The use of biodegradable plastic resins, such as poly(D,L-lactic acid) and poly(D,L-lactic acid):coglycolide, combined with an anti-bacterial agent to produce antibacterial device coatings has been described (Gollwitzer et al., J. Antimicrob Chemother., 51, 585-591 (2003)). Such technology may be readily adapted for preparing anti-biofilm coatings comprising a biofilm inhibitor compound described herein.

A biofilm inhibitor as described herein may also be employed in a “lock solution” (solution or suspension) for use with a central venous catheter (CVC). In standard medical device lock therapies, the lumen(s) of a medical device is filled with a lock solution comprising an anti-bacterial agent (e.g., antiseptic, antibiotic) to prevent bacterial contamination of the device. The lock solution is introduced into the lumen(s) of the device when the device is not in use and then expelled shortly before use. A lock solution according the invention is a solution or suspension comprising a biofilm inhibitor described herein at a concentration sufficient to inhibit bacterial biofilm formation by potentially contaminating bacteria. A lock solution comprising a biofilm inhibitor as described herein may further comprise any of a variety of other compounds that enhance the prevention of bacterial contamination and infection in a medical device. Such additional compounds that may be used in preparing a lock solution of the invention include, but are not limited, one or more antibacterial growth agents (e.g., citrate, EDTA, antibiotic, microbial biocide) at a concentration effective to inhibit growth of (or kill) one or more strains of potentially contaminating bacteria and one or more excipients that provide an additional desirable property to the lock solution other than inhibition of bacterial growth and prevention of biofilm formation. For example, an excipient may provide a density, osmolarity, or viscosity to the lock solution that is similar to the fluid (e.g., blood) that will fill the device lumen when the device is used or implanted. An excipient of a lock solution may also prevent occlusion of the catheter lumen caused by blood clotting and/or formation of a fibrin sheath.

Effective amounts of a biofilm inhibitor to be applied to a surface or otherwise employed in a method or composition to inhibit or prevent biofilm formation may be determined by the skilled practitioner who is familiar with methods for assessing effective amounts of antibiotics, antiseptics (biocides), or previously described biofilm inhibitors on surfaces to meet or exceed standards of authoritative agencies. See, e.g., Guidelines for the prevention of intravascular device-related infections such as those issued by the United States Center for Disease Control (Atlanta, Ga.) (O'Grady et al., Am. J. Infect. Control, 30: 476-489 (2002); examples of biocide and antibiotic impregnated catheters (Potera, Science, 283: 1837, 1839 (1999)); assessment of effectiveness to bacterial challenge by biocide and antibiotic impregnated catheters (Sampath et al., Infect. Control Hosp. Epidemiol., 22: 640-646 (2001)). Such guidelines and procedures are readily adapted to assessing and optimizing the amount and conditions for using a particular biofilm inhibitor described herein to inhibit or prevent bacterial biofilm formation in a particular application (e.g., surface, device, composition, or method).

Additional embodiments and features of the invention will be apparent from the following non-limiting examples.

### EXAMPLES

### Example 1

### Screening for Inhibitors of Staphylococcal Biofilm Formation

In order to identify small molecule compounds that specifically inhibit staphylococcal biofilm formation, the following screening assay was developed. A higher throughput was achieved by formatting the assay for use in flat-bottomed 96-well assay plates (Costar 3590 assay plates, Corning Life Sciences, Lowell, Mass.). The biofilm cultures grew on the bottoms of each well in a surface attached mode. In each assay plate, columns 1 and 12 contained untreated cultures, which served as negative controls (0% biofilm inhibition). Each of the assay wells in columns 2-11 contained a unique small molecule from the Microbiotix Screening Library (MSL) at a final concentration of 100 μM. Assay plates were inoculated with 200 μl/well of a culture of Staphylococcus pidermidis 18972 in 0.5×Tryptic Soy Broth (TSB; Becton Dickinson, Franklin Lakes, N.J.) in which the concentration of glucose was adjusted to 0.25% (w/v). The bacterial inocula were prepared by making a 1:100 dilution of an overnight culture grown in TSB in the media used for the screen. After inoculation, assay plates were sealed with foil tape and incubated at 37° C. for 18-20 hours (h). The optical density at 600 nm (OD₆₀₀) was measured for each well using a VICTOR2V™ multiplate reader (Perkin Elmer, Waltham, Mass.) in order to quantify overall bacterial growth. The assay plates were processed to remove bacterial growth media and non-biofilm cells from the bottom of each assay well. This was accomplished by using a BioTek ELx405™ plate washer (BioTek Instruments, Inc., Winooski, Vt.). Biofilm bacteria were fixed by addition of 50 μl of 95% ethanol for 30 minutes (min). The ethanol was removed, and the fixed biofilm cultures were stained with 50 μl of 0.06% crystal violet (CV) for 60 min. Excess CV was removed by repeated washes using the BioTek ELx405™ plate washer. The amount of CV bound to each assay well was quantified by measuring OD₆₀₀ using a VICTOR2V™ plate reader (Perkin Elmer).

The percent inhibition of overall growth (% INH-Growth) caused by each compound was calculated using the formula:

(1−(OD_{600(compound)}/average OD_{600(negative control)}))×100.

The percent inhibition of biofilm growth produced by each compound was calculated using the formula:

(1−(CV OD_{600(compound)}/average CV OD_{600(negative control)}))×100.

Compounds that produced ≧80% biofilm inhibition and ≦40% overall growth inhibition were scored as primary (positive) hits. Primary hits were retested in triplicate using the assay described above. Primary hits that produced an average biofilm inhibition of ≧80% and overall growth inhibition of ≧40% were scored as confirmed hits.

The entire Microbiotix Screening Library (MSL) was screened for biofilm inhibitors using the assay described above. The MSL contains 87,250 unique compounds and is comprised of commercially-available screening collections purchased from several reputable vendors. The names of the screening collections that comprise the MSL, the numbers of compounds in each collection, and the vendor names are summarized in Table 1 along with the results of the screening for inhibitors of biofilm formation in terms of the numbers of primary, confirmed, and validated hits obtained for each screening collection.

TABLE 1
Results of a Primary Screen of Microbiotix Screening Library
(MSL) for Inhibitors of Staphylococcal Biofilm Formation

| MSL | Number of | Primary | Confirmed | Validated |
|---|---|---|---|---|
| Component | Compounds/ | Hits | Hits | Hits |
| Collection | Collection | (% Hit Rate) | (% Hit Rate) | (% Hit Rate) |
| 1* | 2,000 | 75 (3.75) | 19 (0.95) | 8 (0.4) |
| 2 | 16,000 | 177 (1.11) | 55 (0.34) | 1 (0.006) |
| 3 | 20,000 | 571 (2.86) | 454 (2.27) | 37 (0.19) |
| 4 | 20,000 | 533 (2.67) | 182 (0.91) | 66 (0.33) |
| 5 | 20,000 | 534 (2.67) | 227 (1.14) | 25 (0.125) |
| 6 | 10,000 | 195 (1.95) | 118 (1.18) | 8 (0.08) |
| Total | ~88,000† | 2085 (2.37) | 1055 (1.2) | 145 (0.16) |

*Pilot Study;
†87,250 unique compounds

### Example 2

### Characterization of Confirmed Biofilm Inhibitors from Primary Screen

Confirmed hits from the MSL screening described in Example 1 were evaluated in dose-response assays for anti-biofilm (inhibition of formation) activity, for antibacterial (inhibition of growth) activity, and for cytotoxicity against a human cell line as described below. The data obtained from these assays were used to prioritize compounds for further development and for analyzing structure-activity relationships (SARs).

### Minimal Biofilm Inhibitory Concentration (MBIC) and Minimal Inhibitory Concentration (MIC) Secondary Assay.

A secondary assay provided a quantitative measure of both anti-biofilm activity and antibacterial activity in terms of the Minimal Biofilm Inhibitory Concentration (MBIC) and the Minimal Inhibitory Concentration (MIC), respectively. The MBIC and MIC are defined as the lowest compound concentrations that inhibit biofilm formation and bacterial growth, respectively, by at least 80% (i.e., ≧80%). The MBIC/MIC assay is formatted in a manner that is similar to the Microbroth dilution assays described by the Clinical and Laboratory Standards Institute (CLSI; formerly NCCLS) in protocol M7-A7. The growth conditions were optimized for biofilm growth in 96-well assay plates such that the resulting CV staining was within the linear range of detection. Therefore, the MBIC/MIC assay provided a stringent measure of anti-biofilm activity.

The assay was adapted for several biofilm-forming strains of S. epidermidis, S. aureus, Enterococcus faecalis, and Pseudomonas aeruginosa. Briefly, 96-well assay plates contained a two-fold dilution series for up to 8 compounds (one compound/row) and untreated controls (concentration range of 0.2 μM-100 μM). The assay plates were inoculated with the test bacterial species, e.g., S. epidermidis 18972 (0.5×TSB, 0.25% glucose) or S. aureus ATCC 35556 (0.5×TSB, 1% glucose). The inocula were prepared by diluting an overnight culture 1:100 in fresh media, which corresponds to approximately 5×10⁶ cells/well. After inoculation, the assay plates were sealed with foil tape and incubated for 18 h-20 h at 37° C. The assay plates were processed, and the percent inhibition of growth (% INH-Growth) and percent inhibition of biofilm formation (% INH-Biofilm) were calculated as described above. These data were used to determine the MBIC and MIC, which are defined as the lowest compound concentration that inhibits≧80% biofilm formation and ≧80% overall growth, respectively. Compounds with an MBIC≦10 μM and an MIC/MBIC ratio≧8 for either S. epidermidis or S. aureus were designated as validated hits.

### Spectrum of Anti-Biofilm Activity.

To determine whether compounds exhibit anti-biofilm activity against the most prevalent staphylococcal biofilm pathogens, the MBIC/MIC ratio for each compound was determined using S. epidermidis 18972 and S. aureus ATCC 35556. Compounds that were active against both of these staphylococcal strains tested were given higher priority.

### In Vitro Cytotoxicity Assay (CC₅₀).

Validated hits were tested for general cytotoxicity against a mammalian cell line. In this assay, an assay plate was seeded with an immortalized human cell line (HeLa) and exposed to a series of two-fold dilutions of each test compound for 72 hours in standard media containing 10% Fetal Bovine Serum. After exposure to the compounds, the cellular viability was assessed using Alamar Blue™ (AccuMed International, Inc.), an oxidation-reduction indicator that is useful for quantitatively measuring cell-mediated cytotoxicity. Alamar Blue reduction was quantified using fluorescence measurements, and the data were analyzed using a two-parameter curve-fitting program (Assay Explorer, Elsevier MDL, San Rafael, Calif.) to determine the CC₅₀ value, i.e., the compound concentration that decreases cellular viability by 50%. Compounds with CC₅₀/MBIC≧50 were given highest priority. Validated hits that met the criteria for high priority were re-ordered from the original vendor and re-tested.

Overall, the results of the high throughput screening revealed multiple examples of aryl rhodanine compounds that were relatively potent inhibitors of staphylococcal biofilm formation (MBIC range of 6 μM-25 μM) without affecting planktonic growth (MIC≧100 μM). These compounds specifically inhibited the early stages of biofilm development and did not affect adhesion, PIA/PNAG synthesis, or autolysis.

Table 2 shows representative biofilm inhibitors identified, characterized, and validated in the library screening campaign. Three of the biofilm inhibitors in Table 2 are rhodanine compounds, i.e., 3-(3-chlorophenyl)-5-(3-bromo-4-hydroxy-5-methoxybenzylidene)-2-thioxothiazolidin-4-one (designated MSL-049731), 3-(4-bromophenyl)-5-(3-ethoxy-4-hydroxybenzylidene)-2-thioxothiazolidin-4-one (MSL-049293), and 3-(4-chlorophenyl)-5-(3-chloro-5-ethoxy-4-hydroxybenzylidene)thiazolidine-2,4-dione (designated MSL-6519056), and a furanone biofilm inhibitor, i.e., 3-(4-hydroxy-3-methoxybenzylidene)-5-(2,4-dimethoxyphenyl)furan-2(3H)-one (MSL-051097).

TABLE 2
Results of Secondary Assay of Biofilm Inhibitors from Library Screening

| | | S. epidermidis | | S. aureus | | |
|---|---|---|---|---|---|---|
| | | 18972 | | ATCC 35556 | | HeLa |
| | | MIC† | MBIC* | MIC† | MBIC* | CC₅₀ ‡ |
| ID NO. | STRUCTURE | (μM) | (μM) | (μM) | (μM) | (μM) |
| MSL- 049731 | 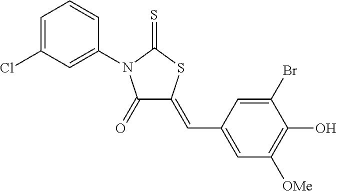 | ≧100 | 25 | ≧100 | 6.25 | ND |
| MSL- 049293 | 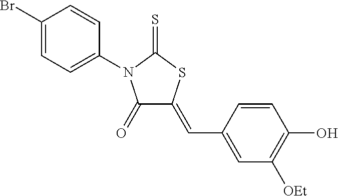 | ≧100 | 12.5 | ≧100 | 1.5625 | ≧100 |
| MSL- 6519056 | 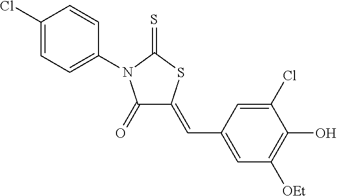 | ≧213 | 13.3 | ≧213 | 6.7 | ≧244 |
| MSL- 051097 | 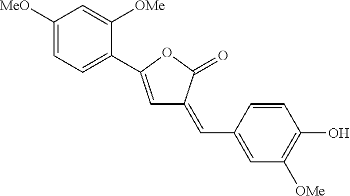 | ≧100 | 25 | ≧100 | 6.25 | 29.42 |

### Example 3

### Synthesis of Additional Biofilm Inhibitors

The results of the library screenings described above led to the design, synthesis, and characterization of additional biofilm inhibitors.

### Example 3.1

### Synthesis of 3-(4-fluorophenyl)-5-(3-ethoxy-4-hydroxybenzylidene)-2-thioxothiazolidin-4-one (Compound 4)

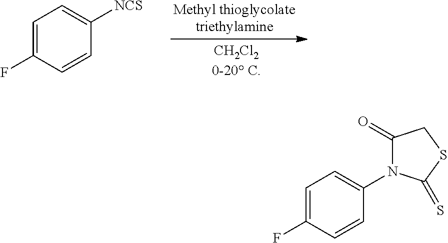

### 3-(4-fluorophenyl)-2-thioxothiazolidin-4-one

To a solution of 4-fluorophenyl isothiocyanate (3.0 g, 19.6 mmol) and methyl thioglycolate (1.78 mL, 17.5 mmol, 1.0 eq) in dichloromethane (15 mL) was added triethylamine (0.59 g, 5.9 mmol, 0.3 eq), dropwise, over 10 min at room temperature. The reaction was stirred and additional 10 min at room temperature, then the resulting solids were filtered, washed with 50% ether/hexanes and re-crystallized from EtOAc/Hex/MeOH to yield 3.23 g (73%) of product as white flakes.

¹H-NMR (DMSO-d₆): δ 7.41-7.33 (m, 4H), 4.3 (s, 2H).

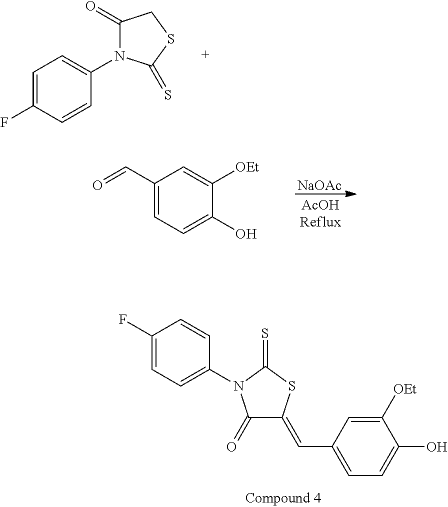

### 3-(4-fluorophenyl)-5-(3-ethoxy-4-hydroxybenzylidene)-2-thioxothiazolidin-4-one (Compound 4)

To a solution of 4-fluorophenyl rhodanine (100 mg, 0.44 mmol) and 3-ethoxy-4-hydroxy benzaldehyde (73 mg, 0.44 mmol, 1.0 eq) in glacial acetic acid (10 mL) was added sodium acetate (108 mg, 1.3 mmol, 3.0 eq). The resulting clear solution was refluxed at 130° C. for 2.5 days, then cooled to room temperature and poured into water (30 mL). The mixture was stirred for 15 min, and then the solids were filtered, washed with water (2×20 mL) and dried to yield a yellow solid. The solid was recrystallized from CH₃CN to yield 85 mg (51%) of product as a yellow fluffy solid.

¹H-NMR (DMSO-d₆): δ 10.13 (b, 1H), 7.76 (s, 1H), 7.51-7.4 (m, 4H), 7.23 (d, 1H), 7.17 (dd, 1H), 6.9 (d, 1H), 4.11 (q, 2H), 1.38 (t, 3H).

### Example 3.2

### Synthesis of 3-(3-fluorophenyl)-5-(3-ethoxy-4-hydroxybenzylidene)-2-thioxothiazolidin-4-one (Compound 8)

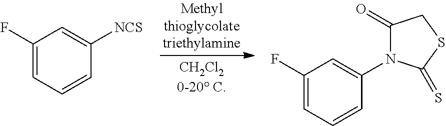

### 3-(3-fluorophenyl)-2-thioxothiazolidin-4-one

To a solution of 3-fluorophenyl isothiocyanate (3.0 g, 19.6 mmol) and methyl thioglycolate (1.78 mL, 17.5 mmol, 1.0 eq) in dichloromethane (15 mL) was added triethylamine (0.59 g, 5.9 mmol, 0.3 eq), dropwise over 10 min at room temperature. The reaction was stirred and additional 10 min at room temperature, then the resulting solids were filtered, washed with 50% ether/hexanes and re-crystallized from CH₃CN to yield 3.0 g (67%) of product as a pink crystalline solid.

¹H-NMR (DMSO-d₆): δ 7.46-7.39 (q, 1H), 7.16-7.1 (t, 1H), 6.98-6.9 (m, 2H), 2.38 (s, 2H).

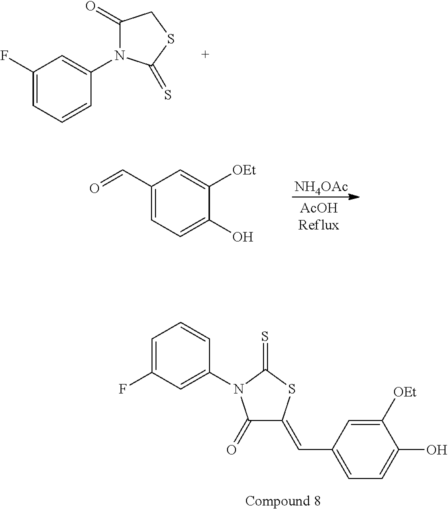

### 3-(3-fluorophenyl)-5-(3-ethoxy-4-hydroxybenzylidene)-2-thioxothiazolidin-4-one (Compound 8)

To a solution of 3-fluorophenyl rhodanine (100 mg, 0.44 mmol) and 3-ethoxy-4-hydroxy benzaldehyde (73 mg, 0.44 mmol, 1.0 eq) in glacial acetic acid (10 mL) was added ammonium acetate (102 mg, 1.3 mmol, 3.0 eq). The resulting clear solution was refluxed at 130° C. for 2 days, then cooled to room temperature and poured into water (30 mL). The mixture was stirred for 15 min, and then the solids were filtered, washed with water (2×20 mL) and dried to yield a yellow solid. The solid was recrystallized from CH₃CN to yield 37 mg (22%) of product as a yellow granular solid.

¹H-NMR (DMSO-d₆): δ 10.20 (s, 1H), 7.77 (s, 1H), 7.62-7.58 (m, 1H), 7.43-7.37 (m, 2H), 7.20 (dd, 1H), 7.24 (s, 1H), 7.18 (dd, 1H), 6.99 (d, 1H), 4.11 (q, 2H), 1.38 (t, 3H).

### Example 3.3

### Synthesis of 3-(pyridin-3-yl)-5-(3-ethoxy-4-hydroxybenzylidene)-2-thioxothiazolidin-4-one (Compound 36)

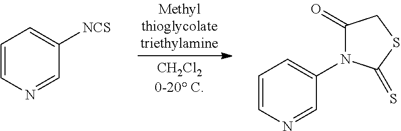

### 3-(3-pyridyl)-2-thioxothiazolidin-4-one

A solution of 3-pyridyl isothiocyanate (1.0 g, 7.3 mmol) and methyl thioglycolate (0.67 mL, 7.3 mmol, 1.0 eq) in dichloromethane (15 mL) was cooled to 0° C. in an ice bath. Triethylamine (0.31 mL, 2.2 mmol, 0.3 eq), was added dropwise over 10 min at that temperature. The reaction was stirred an additional 30 min warming to room temperature, and was then diluted with additional DCM (50 mL), washed with water (2×30 mL), then dried over MgSO4, filtered and evaporated to yield a dark residue. The residue was subjected to silica gel filtration, and eluted with 20% EtOAc/hexane. The filtrate was evaporated to yield 0.50 g (32%) of product as a cream-colored powder.

¹H-NMR (DMSO-d₆): δ 8.67 (d, 1H), 8.49 (d, 1H), 7.78 (dd, 1H), 7.60 (dd, 1H J), 4.41 (s, 2H).

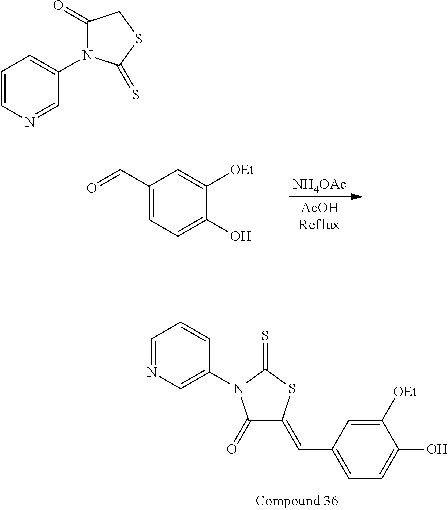

### 3-(pyridin-3-yl)-5-(3-ethoxy-4-hydroxybenzylidene)-2-thioxothiazolidin-4-one (Compound 36)

To a solution of 3-(3-pyridyl)-rhodanine (100 mg, 0.48 mmol) and 3-ethoxy-4-hydroxy benzaldehyde (79 mg, 0.48 mmol, 1.0 eq) in glacial acetic acid (10 mL) was added ammonium acetate (110 mg, 1.4 mmol, 3.0 eq). The resulting clear solution was refluxed at 130° C. for 3 days, then cooled to room temperature and poured into water (50 mL). The mixture was stirred for 10 min, and then the solids were filtered, washed with water (2×20 mL) and dried to yield a yellow solid. The solid was recrystallized from CH₃CN to yield 99 mg (58%) of product as a yellow crystalline solid.

¹H-NMR (DMSO-d₆): δ 8.71 (d, 1H), 8.69-8.64 (m, 1H), 7.95-7.93 (m, 1H), 7.80 (s, 1H), 7.65-7.61 (m, 1H), 7.25 (s, 1H), 7.19 (dd, 1H), 7.0 (d, 1H), 4.12 (q, 2H), 1.38 (t, 3H).

### Example 3.4

### Synthesis of 3-(4-fluorophenyl)-5-(3-allyloxy-4-hydroxybenzylidene)-2-thioxothiazolidin-4-one (Compound 29)

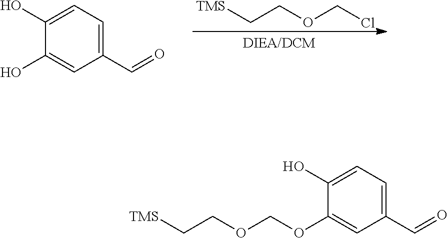

### 4-hydroxy-3-((2-(trimethylsilyl)ethoxy)methoxy)benzaldehyde

To a solution of 3,4-dimethoxy benzaldehyde (5.0 g, 36.2 mmol), and chloromethyl trimethylsilylethyl ether (6.03 g, 36.2 mmol, 1.0 eq) in DCM (50 mL) was added diisopropyl ethyl amine (7.9 mL, 45 mmol, 1.25 eq). The resulting clear solution was stirred at room temperature for 2 h. The solvent was removed under vacuum, and the residue was partitioned between H₂O and EtOAc. The organic layer was evaporated, and the residue subjected to flash chromatography on silica gel with 7% EtOAc/Hexanes. Fractions containing product were pooled and evaporated to yield 4.66 g, (51%) of product as a tan-colored oil.

¹H-NMR (DMSO-d₆): δ 9.82 (s, 1H), 9.66 (s, 1H), 7.41-7.34 (m, 2H), 7.24 (d, 1H), 5.36 (s, 2H), 3.78 (t, 2H), 0.93 (t, 2H), 0.0 (s, 9H).

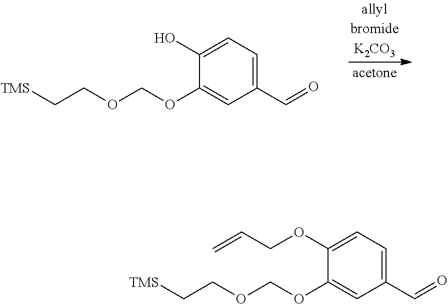

### 4-allyloxy-3-((2-(trimethylsilyl)ethoxy)methoxy)benzaldehyde

A mixture of 4-hydroxy-3-((2-(trimethylsilyl)ethoxy)methoxy)benzaldehyde (200 mg, 0.75 mmol), allyl bromide (135 mg, 1.1 mmol, 1.5 eq.) and K₂CO₃ (309 mg, 2.2 mmol, 3.0 eq.) in acetone (4 mL) was heated by microwave (60° C.) for 1 h. The mixture was filtered, and the residual solids were washed with acetone (10 mL). The filtrate was evaporated, and the residue dissolved in a minimum of EtOAc, then filtered through a pad of silica gel, and eluted with 5% EtOAc/hexane. The filtrate was evaporated to yield 177 mg (77%) of product as a white solid.

¹H-NMR (DMSO-d₆): δ 9.85 (s, 1H), 7.45-7.42 (m, 2H), 7.31 (m, 1H), 6.11-6.03 (m, 1H), 5.47-5.29 (m, 4H), 4.70-4.67 (m, 2H), 3.84-3.78 (m, 2H), 0.99-0.93 (m, 2H), 0.00 (s, 9H).

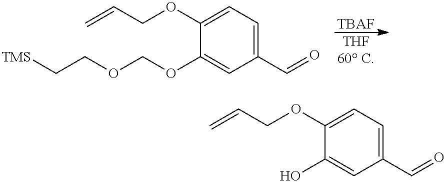

### 4-allyloxy-3-hydroxybenzaldehyde

To a solution of tetrabutylammonium fluoride in THF (1.0 M, 3.0 mL, 3.0 mmol) was added 4-allyloxy-3-((2-(trimethylsilyl)ethoxy)methoxy)benzaldehyde. The clear solution was heated to 60° C. for 3 d. The solvent was then evaporated, and the residue subjected to flash chromatography on silica gel with 7% EtOAc/hexane. Product-containing fractions were pooled and evaporated to yield 66 mg (65%) of product as a white solid.

¹H-NMR (DMSO-d₆): δ 9.82 (s, 1H), 7.45-7.42 (dd, 2H), 7.056 (d, 1H) 6.22 (s, 1H), 6.12-6.02 (m, 1H), 5.47-5.34 (m, 2H), 4.699-4.68 (dt, 2H).

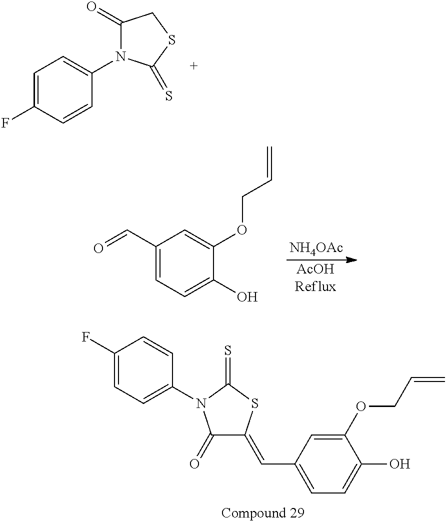

### 3-(4-fluorophenyl)-5-(3-allyloxy-4-hydroxybenzylidene)-2-thioxothiazolidin-4-one (Compound 29)

To a solution of 4-fluorophenyl rhodanine (84 mg, 0.37 mmol) and 3-ethoxy-4-hydroxy benzaldehyde (66 mg, 0.37 mmol, 1.0 eq) in glacial acetic acid (10 mL) was added ammonium acetate (86 mg, 1.1 mmol, 3.0 eq). The resulting clear solution was heated to 130° C. via microwave for 15 min, then cooled to room temperature and poured into water (30 mL). The mixture was stirred for 15 min, and then the solids were filtered, washed with water (2×20 mL) and dried to yield a yellow solid. The solid was recrystallized from CH₃CN to yield 85 mg (51%) of product as a yellow fluffy solid.

¹H-NMR (DMSO-d₆): δ 10.22 (b, 1H), 7.74 (s, 1H), 7.51-7.37 (m, 4H), 7.25 (d, 1H), 7.19 (dd, 1H), 7.00 (d, 1H), 6.13-6.02 (m, 1H), 5.49 (dd, 1H), 5.30 (dd, 1H), 4.67 (d, 2H).

### Example 3.5

### Synthesis of 3-(6-fluoropyridin-3-yl)-5-(3-ethoxy-4-hydroxybenzylidene)-2-thioxothiazolidin-4-one (Compound 40)

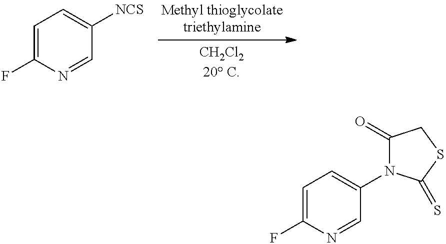

### 3-(6-fluoro-3-pyridyl)-2-thioxothiazolidin-4-one

To a solution of 6-fluoro-3-pyridyl isothiocyanate (2.5 g, 16 mmol) and methyl thioglycolate (1.57 mL, 16 mmol, 1.0 eq) in dichloromethane (15 mL) was added triethylamine (0.31 mL, 2.2 mmol, 0.3 eq), dropwise over 20 min. The reaction was stirred an additional 20 min at that temperature, the solvent was removed, and the residue subjected to flash chromatography on silica gel with 50% EtOAc/hexane. Fractions containing product were pooled and evaporated to yield an off-white solid which was recrystallized from 10% EtOAc/hexane to yield 1.16 g (31%) of product as a light brown crystalline solid.

¹H-NMR (DMSO-d₆): δ 8.22 (t, 1H), 8.03-8.97 (m, 1H), 7.43-7.41 (dd, 1H), 4.40 (s, 2H).

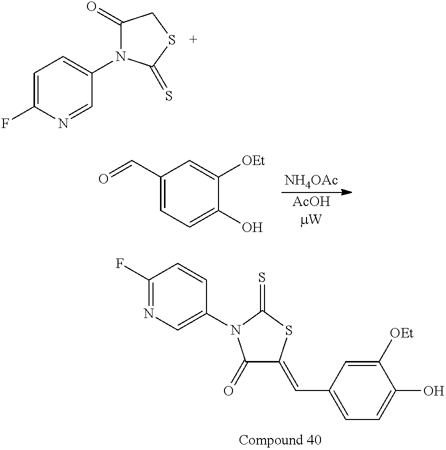

### 3-(6-fluoropyridin-3-yl)-5-(3-ethoxy-4-hydroxybenzylidene)-2-thioxothiazolidin-4-one (Compound 40)

To a solution of 6-fluoro-3-pyridyl rhodanine (100 mg, 0.44 mmol) and 3-ethoxy-4-hydroxy benzaldehyde (66 mg, 0.44 mmol, 1.0 eq) in glacial acetic acid (10 mL) was added ammonium acetate (102 mg, 1.3 mmol, 3.0 eq). The resulting clear solution was heated to 130° C. via microwave for 15 min, then cooled to room temperature and poured into water (30 mL). The mixture was stirred for 15 min, and then the solids were filtered, washed with water (2×20 mL) and dried to yield a yellow solid. The solid was recrystallized from CH₃CN to yield 85 mg (51%) of product as a yellow fluffy solid.

¹H-NMR (DMSO-d₆): δ 10.12 (s, 1H), 8.37 (d, 1H), 8.15 (td, 1H), 7.80 (s, 1H), 7.50 (dd, 1H), 7.25 (d, 1H), 7.19 (d, 1H), 6.99 (d, 1H), 4.12 (q, 2H), 1.38 (t, 3H).

### Example 3.6

### Synthesis of 3-(3-cyanophenyl)-5-(3-ethoxy-4-hydroxybenzylidene)-2-thioxothiazolidin-4-one (Compound 34)

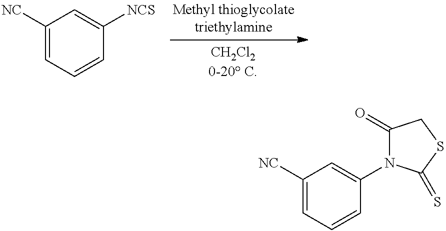

### 3-(3-cyanophenyl)-2-thioxothiazolidin-4-one

A solution of 3-cyanophenyl isothiocyanate (1.0 g, 6.2 mmol) and methyl thioglycolate (1.14 mL, 6.2 mmol, 1.0 eq) in dichloromethane (15 mL) was cooled to 0° C. in an ice bath. Triethylamine (0.26 mL, 1.9 mmol, 0.3 eq), was added dropwise over 10 min at that temperature. The reaction was stirred an additional 1 h, warming to room temperature, and was then diluted with additional DCM (50 mL), washed with water (2×30 mL), then dried over MgSO4, filtered and evaporated to yield a dark residue. The residue was subjected to silica gel filtration, and eluted with 40% EtOAc/hexane. The filtrate was evaporated to yield 1.14 g (78%) of product as a granular yellow solid.

¹H-NMR (DMSO-d₆): δ 7.99 (dt, 1H), 7.86 (t, 1H), 7.72 (t, 1H), 7.68 (dt, 1H), 4.40 (s, 2H).

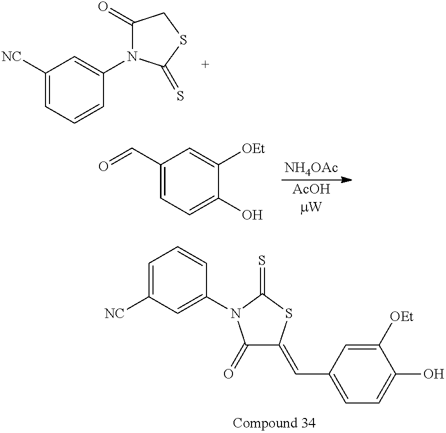

### 3-(3-cyanophenyl)-5-(3-ethoxy-4-hydroxybenzylidene)-2-thioxothiazolidin-4-one (Compound 34)

To a solution of 3-cyanophenyl rhodanine (100 mg, 0.62 mmol) and 3-ethoxy-4-hydroxy benzaldehyde (103 mg, 0.62 mmol, 1.0 eq) in glacial acetic acid (3 mL) was added ammonium acetate (143 mg, 1.8 mmol, 3.0 eq). The resulting clear solution was heated to 130° C. via microwave for 15 min, then cooled to room temperature and poured into water (30 mL). The mixture was stirred for 15 min, and then the solids were filtered, washed with water (2×20 mL) and dried to yield a yellow solid. The solid was recrystallized from CH₃CN to yield 125 mg (53%) of product as a yellow powder.

¹H-NMR (DMSO-d₆): δ 10.12 (s, 1H), 8.02 (d, 2H), 7.80 (d, 3H), 7.25 (s, 1H), 7.19 (d, 1H), 6.99 (d, 1H), 4.12 (q, 2H), 1.38 (t, 3H).

### Example 3.7

### Synthesis of 3-(3-methoxycarbonylphenyl)-5-(3-ethoxy-4-hydroxybenzylidene)-2-thioxothiazolidin-4-one (Compound 49)

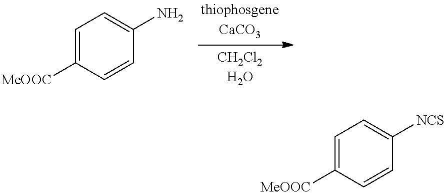

### 4-methoxycarbonylphenyl isothiocyanate

To a suspension of methyl 4-aminobenzoate (5.0 g, 33 mmol) and CaCO3 (8.61 g, 86 mmol, 2.6 eq.) in water (25 mL) and dichloromethane (25 mL) was added thiophosgene (3.55 mL, 46 mmol), dropwise, over 5 min. The mixture was stirred vigorously for 16 h, then filtered through Celite, and separated. The aqueous layer was extracted with dichloromethane (50 mL), and the combined organic layers were dried over MgSO4, filtered, and evaporated to yield a slightly brown residue. The Residue was recrystallized from a minimum of dichloromethane to yield 4.0 g (80%) of product as off-white crystalline needles.

¹H-NMR (DMSO-d₆): δ 7.9-7.87 (m, 2H), 7.42-7.39 (m, 2H), 3.77 (s, 3H).

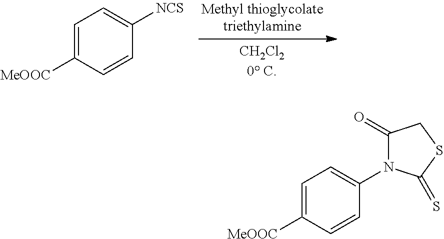

### 3-(3-methoxycarbonylphenyl)-2-thioxothiazolidin-4-one

A solution of 3-methoxycarbonylphenyl isothiocyanate (3.4 g, 23 mmol) and methyl thioglycolate (2.08 mL, 23 mmol, 1.0 eq) in dichloromethane (20 mL) was cooled to 0° C. in an ice bath. Triethylamine (0.68 mL, 6.8 mmol, 0.3 eq), was added dropwise over 30 min at that temperature. The reaction was then diluted with additional DCM (50 mL), washed with water (2×30 mL), then dried over MgSO4, filtered and evaporated to yield a dark residue. The residue was subjected to flash chromatography on silica gel with 10% EtOAc/hexane. Fractions containing product were pooled and evaporated to yield 2.92 g (48%) of product as a light yellow solid.

¹H-NMR (DMSO-d₆): δ 8.11 (d, 2H), 7.46 (d, 2H), 4.4 (s, 2H).

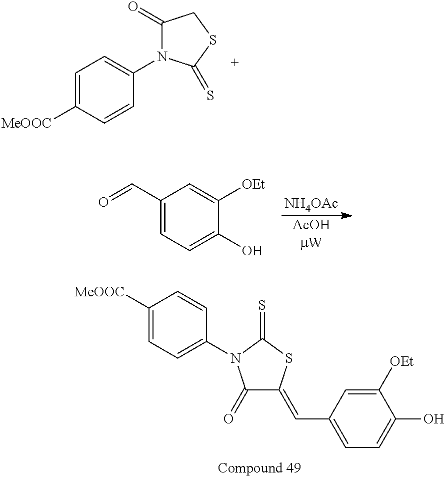

### 3-(3-methoxycarbonylphenyl)-5-(3-ethoxy-4-hydroxybenzylidene)-2-thioxothiazolidin-4-one (Compound 49)

To a solution of 3-methoxycarbonylphenyl rhodanine (100 mg, 0.37 mmol) and 3-ethoxy-4-hydroxy benzaldehyde (61 mg, 0.37 mmol, 1.0 eq) in glacial acetic acid (10 mL) was added ammonium acetate (108 mg, 1.1 mmol, 3.0 eq). The resulting clear solution was heated to 130° C. via microwave for 15 min, then cooled to room temperature and poured into water (30 mL). The mixture was stirred for 15 min, and then the solids were filtered, washed with water (2×20 mL) and dried to yield a yellow solid. The solid was recrystallized from CH₃CN to yield 85 mg (51%) of product as a fluffy yellow solid.

¹H-NMR (DMSO-d₆): δ 10.10 (b, 1H), 8.13 (d, 2H), 7.77 (s, 1H), 7.6 (d, 2H), 7.24 (d, 1H), 7.18 (dd, 1H), 6.99 (d, 1H), 4.12 (q, 2H), 3.90 (s, 3H), 1.38 (t, 3H).

### Example 3.8

### Synthesis of 3-(4-fluorophenyl)-5-(3-ethoxy-4-hydroxybenzylidene) imidazolidine-2,4-dione (Compound 58)

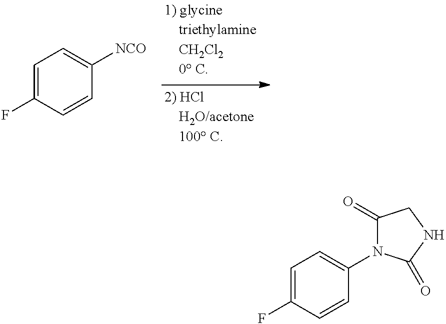

### 3-(4-fluorophenyl)imidazolidine-2,4-dione

To a suspension of glycine (548 mg, 7.3 mmol) in dichloromethane (10 mL) was added triethylamine (1.0 mL, 7.3 mmol, 1.0 eq.) and a solution of 4-fluorophenyl isocyanate (1.0 g, 7.3 mmol, 1.0 eq.). The resulting mixture was stirred at room temperature for 1 h then filtered. The filtrate was evaporated, and the residue was dissolved in 6.5 N aqueous HCl (4 mL) and acetone (1 mL). The mixture was heated in a sealed tube at 100° C. for 2 d, then cooled to room temperature, and filtered. The resulting solids were washed with 30% EtOAc/hexane (10 mL) and dried to yield 90 mg (6%) of product as a pale white solid.

¹H-NMR (DMSO-d₆): δ 8.31 (s, 1H), 7.42-7.28 (m, 4H), 4.05 (s, 2H).

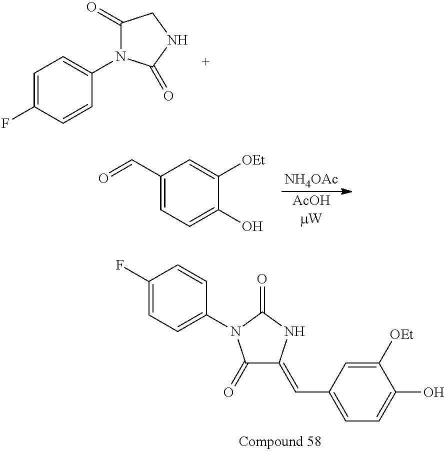

### 3-(4-fluorophenyl)-5-(3-ethoxy-4-hydroxybenzylidene)imidazolidine-2,4-dione (Compound 58)

To a solution of 4-fluorophenyl hydantoin (82 mg, 0.42 mmol) and 3-ethoxy-4-hydroxy benzaldehyde (70 mg, 0.42 mmol, 1.0 eq) in glacial acetic acid (3 mL) was added ammonium acetate (97 mg, 1.3 mmol, 3.0 eq). The resulting clear solution was heated to 130° C. via microwave for 30 min, then cooled to room temperature and poured into water (30 mL). The mixture was partitioned into H₂O (20 mL) and EtOAc (50 mL). The organic layer was separated, dried over MgSO₄, filtered, and evaporated to yield a solid which was recrystallized from CH₃CN to yield 22 mg (27%) of product as a white, flaky solid.

¹H-NMR (DMSO-d₆): δ 10.89 (b, 1H), 9.44 (b, 1H), 7.51-7.48 (m, 2H), 7.38-732 (m, 2H), 7.19-7.14 (m, 2H), 6.85 (d, 1H), 6.57 (s, 1H), 4.13 (q, 2H), 1.35 (t, 3H).

### Example 3.9

### Synthesis of 3-(4-fluorophenyl)-5-(3-ethoxy-4-hydroxybenzylidene) thiazolidine-2,4-dione (Compound 60)

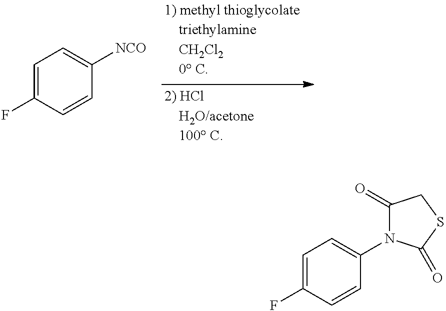

### 3-(4-fluorophenyl)thiazolidine-2,4-dione

To a solution of 4-fluorophenyl isocyanate (1.0 g, 7.3 mmol) and methyl thioglycolate (0.64 mL, 7.3 mmol, 1.0 eq) in dichloromethane (15 mL) was added triethylamine (0.31 mL, 2.2 mmol, 0.3 eq), dropwise, over 10 min at room temperature. The resulting mixture was stirred at room temperature for 30 min, then partitioned between EtOAc (25 mL) and H₂O (25 mL). The organic layer was dried over MgSO₄, filtered, and evaporated to yield a residue, which was dissolved in 6.5 N aqueous HCl (16 mL) and acetone (4 mL). The mixture was heated in a sealed tube at 100° C. for 60 min, then cooled to room temperature, and filtered. The resulting solids were washed with 50% ethyl ether/hexane (100 mL) and dried to yield 880 mg (57%) of product as a fluffy white solid.

¹H-NMR (DMSO-d₆): δ 7.38-7.35 (m, 4H), 4.29 (s, 2H).

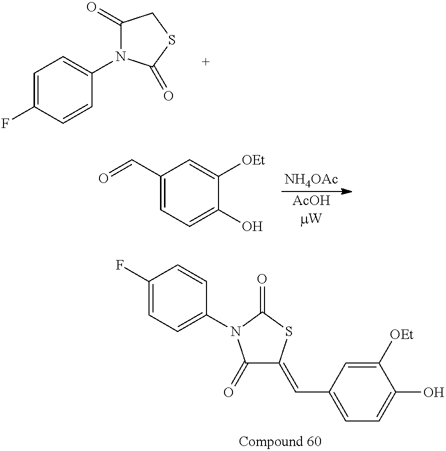

### 3-(4-fluorophenyl)-5-(3-ethoxy-4-hydroxybenzylidene)thiazolidine-2,4-dione (Compound 60)

To a solution of 4-fluorophenyl thiazolidine-2,4-dione (100 mg, 0.47 mmol) and 3-ethoxy-4-hydroxy benzaldehyde (79 mg, 0.47 mmol, 1.0 eq) in glacial acetic acid (3 mL) was added ammonium acetate (109 mg, 1.4 mmol, 3.0 eq). The resulting clear solution was heated to 130° C. via microwave for 15 min, then cooled to room temperature and poured into water (30 mL). The mixture was stirred for 15 min, and then the solids were filtered, washed with water (2×20 mL) and dried to yield a yellow solid. The solid was recrystallized from CH₃CN to yield 84 mg (50%) of product as a white powder.

¹H-NMR (DMSO-d₆): δ 9.95 (s, 1H), 7.90 (s, 1H), 7.54-7.49 (m, 2H), 7.41-7.35 (m, 2H), 7.24 (s, 1H), 7.16-7.13 (m, 1H), 6.97 (d, 1H), 4.09 (q, 2H), 1.37 (t, 3H).

### Example 3.10

### Synthesis of 3-(4-fluorophenyl)-5-(3-ethoxy-4-hydroxybenzylidene)-2-thioxoimidazolidin-4-one (Compound 62)

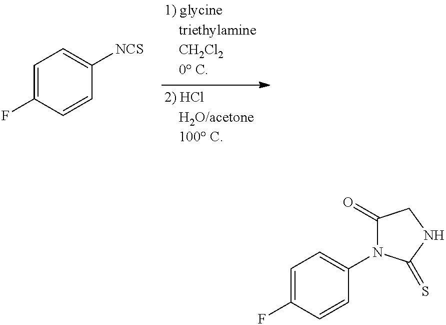

### 3-(4-fluorophenyl)-2-thioxoimidazolidin-4-one

To a suspension of glycine (490 mg, 6.5 mmol) in dichloromethane (10 mL) was added triethylamine (0.91 mL, 6.5 mmol, 1.0 eq.) and a solution of 4-fluorophenyl isothiocyanate (1.0 g, 6.5 mmol, 1.0 eq.). The resulting mixture was heated to 100° C. via microwave for 90 min, then cooled to room temperature and partitioned into EtOAc (50 mL) and H₂O (50 mL). The organic layer was dried over MgSO₄, filtered, and evaporated to yield a residue, which was dissolved in 6.5 N aqueous HCl (16 mL) and acetone (4 mL). The mixture was heated via microwave to 100° C. for 60 min, then cooled to room temperature and partitioned into EtOAc (50 mL) and H₂O (50 mL). The organic layer was dried over MgSO₄, filtered, and evaporated to yield a residue. The crude product was subjected to flash chromatography on silica gel with 35% EtOAc/hexane. Fractions containing product were pooled and evaporated to yield 270 mg (20%) of product as a tan solid.

¹H-NMR (DMSO-d₆): δ 10.41 (s, 1H), 7.34-7.32 (m, 4H), 4.3 (s, 2H).

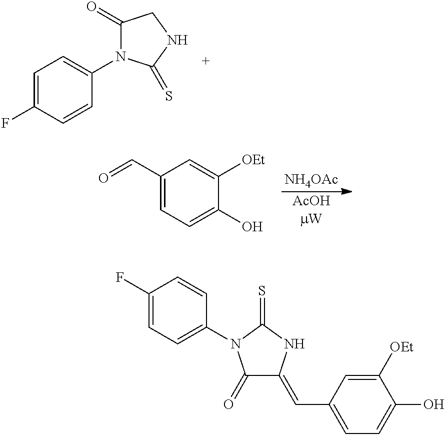

### Compound 62

### 3-(4-fluorophenyl)-5-(3-ethoxy-4-hydroxybenzylidene)-2-thioxoimidazolidin-4-one (Compound 62)

To a solution of 4-fluorophenyl thiohydantoin (100 mg, 0.47 mmol) and 3-ethoxy-4-hydroxy benzaldehyde (79 mg, 0.47 mmol, 1.0 eq) in glacial acetic acid (3 mL) was added ammonium acetate (109 mg, 1.4 mmol, 3.0 eq). The resulting clear solution was heated to 130° C. via microwave for 20 min, then cooled to room temperature and poured into water (30 mL). The mixture was stirred for 15 min, and then the solids were filtered, washed with water (2×20 mL) and dried to yield a yellow solid. The solid was recrystallized from CH₃CN to yield 44 mg (26%) of product as a yellow powder.

¹H-NMR (DMSO-d₆): δ 12.52 (br, 1H), 9.64 (b, 1H), 7.44-7.36 (m, 6H), 6.87 (d, 1H), 6.63 (s, 1H), 4.15 (q, 2H), 1.37 (t, 3H).

Additional biofilm inhibitors were also synthesized and characterized. A list of these compounds and those described above are provided in Table 3, below.

TABLE 3
Biofilm Inhibitor Compounds Synthesized

| | 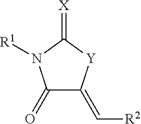 | | | | |
|---|---|---|---|---|---|
| No. | R¹ | R² | X | Y | Name |
| 1 | 4-F | 3-OMe, 4- | S | S | (Z)-3-(4-fluorophenyl)-5- |
| | phenyl | OH, 5-Br | | | (5-bromo-4-hydroxy-3- |
| | | phenyl | | | methoxybenzylidene)- |
| | | | | | 2-thioxothiazolidin-4-one |
| 2 | 4-F | 3-OMe, 4- | S | S | (Z)-3-(4-fluorophenyl)-5- |
| | phenyl | OH, 5-Cl | | | (5-chloro-4-hydroxy-3- |
| | | phenyl | | | methoxybenzylidene)- |
| | | | | | 2-thioxothiazolidin-4-one |
| 3 | 4-F | 3-OMe, 4- | S | S | (Z)-3-(4-fluorophenyl)-5- |
| | phenyl | OH phenyl | | | (3-hydroxy-4- |
| | | | | | methoxybenzylidene)-2- |
| | | | | | thioxothiazolidin-4-one |
| 4 | 4-F | 3-OEt, 4-OH | S | S | (Z)-3-(4-fluorophenyl)-5- |
| | phenyl | phenyl | | | (3-hydroxy-4- |
| | | | | | ethoxybenzylidene)-2- |
| | | | | | thioxothiazolidin-4-one |
| 5 | 3-F | 3-OMe, 4- | S | S | (Z)-3-(3-fluorophenyl)-5- |
| | phenyl | OH, 5-Br | | | (5-bromo-4-hydroxy-3- |
| | | phenyl | | | methoxybenzylidene)- |
| | | | | | 2-thioxothiazolidin-4-one |
| 6 | 3-F | 3-OMe, 4- | S | S | (Z)-3-(3-fluorophenyl)-5- |
| | phenyl | OH, 5-Cl | | | (5-chloro-4-hydroxy-3- |
| | | phenyl | | | methoxybenzylidene)- |
| | | | | | 2-thioxothiazolidin-4-one |
| 7 | 3-F | 3-OMe, 4- | S | S | (Z)-3-(3-fluorophenyl)- |
| | phenyl | OH phenyl | | | 5-(3-hydroxy-4- |
| | | | | | methoxybenzylidene)-2- |
| | | | | | thioxothiazolidin-4-one |
| 8 | 3-F | 3-OEt, 4-OH | S | S | (Z)-3-(3-fluorophenyl)-5-(3- |
| | phenyl | phenyl | | | hydroxy-4- |
| | | | | | ethoxybenzylidene)-2- |
| | | | | | thioxothiazolidin-4-one |
| 9 | 4-Cl | 3-OMe, 4- | S | S | (Z)-3-(4-chlorophenyl)-5- |
| | phenyl | OH, 5-Br | | | (5-bromo-4-hydroxy-3- |
| | | phenyl | | | methoxybenzylidene)-2- |
| | | | | | thioxothiazolidin-4-one |
| 10 | 4-Cl | 3-OMe, 4- | S | S | (Z)-3-(4-chlorophenyl)-5- |
| | phenyl | OH, 5-Cl | | | (5-chloro-4-hydroxy-3- |
| | | phenyl | | | methoxybenzylidene)-2- |
| | | | | | thioxothiazolidin-4-one |
| 11 | 4-Cl | 3-OMe, 4- | S | S | (Z)-3-(4-chlorophenyl)- |
| | phenyl | OH phenyl | | | 5-(3-hydroxy-4- |
| | | | | | methoxybenzylidene)-2- |
| | | | | | thioxothiazolidin-4-one |
| 12 | 4-Cl | 3-OEt, 4-OH | S | S | (Z)-3-(4-chlorophenyl)-5- |
| | phenyl | phenyl | | | (3-hydroxy-4- |
| | | | | | ethoxybenzylidene)-2- |
| | | | | | thioxothiazolidin-4-one |
| 13 | 3-Cl | 3-OMe, 4- | S | S | (Z)-3-(3-chlorophenyl)-5- |
| | phenyl | OH, 5-Br | | | (5-bromo-4-hydroxy-3- |
| | | phenyl | | | methoxybenzylidene)-2- |
| | | | | | thioxothiazolidin-4-one |
| 14 | 3-Cl | 3-OMe, 4- | S | S | (Z)-3-(3-chlorophenyl)-5- |
| | phenyl | OH, 5-Cl | | | (5-chloro-4-hydroxy-3- |
| | | phenyl | | | methoxybenzylidene)-2- |
| | | | | | thioxothiazolidin-4-one |
| 15 | 3-Cl | 3-OMe, 4- | S | S | (Z)-3-(3-chlorophenyl)-5- |
| | phenyl | OH phenyl | | | (3-hydroxy-4- |
| | | | | | methoxybenzylidene)-2- |
| | | | | | thioxothiazolidin-4-one |
| 16 | 3-Cl | 3-OEt, 4-OH | S | S | (Z)-3-(3-chlorophenyl)-5- |
| | phenyl | phenyl | | | (3-hydroxy-4-ethoxy- |
| | | | | | benzylidene)-2- |
| | | | | | thioxothiazolidin-4-one |
| 17 | 3,4- | 3-OMe, 4- | S | S | (Z)-3-(3,4-dichlorophenyl)-5- |
| | diCl | OH, 5-Br | | | (5-bromo-4-hydroxy-3- |
| | phenyl | phenyl | | | methoxybenzylidene)-2- |
| | | | | | thioxothiazolidin-4-one |
| 18 | 3,4- | 3-OMe, 4- | S | S | (Z)-3-(3,4-dichlorophenyl)-5-(5- |
| | diCl | OH, 5-Cl | | | chloro-4-hydroxy-3- |
| | phenyl | phenyl | | | methoxybenzylidene)-2- |
| | | | | | thioxothiazolidin-4-one |
| 19 | 3,4- | 3-OMe, 4- | S | S | (Z)-3-(3,4-dichlorophenyl)-5-(3- |
| | diCl | OH phenyl | | | hydroxy-4-methoxybenzylidene)- |
| | phenyl | | | | 2-thioxothiazolidin-4-one |
| 20 | 3,4- | 3-OEt, 4-OH | S | S | (Z)-3-(3,4-dichlorophenyl)-5-(3- |
| | diCl | phenyl | | | hydroxy-4-ethoxybenzylidene)-2- |
| | phenyl | | | | thioxothiazolidin-4-one |
| 21 | 4-F | 3,4-diOH | S | S | (Z)-3-(4-fluorophenyl)-5-(3,4- |
| | phenyl | phenyl | | | dihydroxybenzylidene)-2- |
| | | | | | thioxothiazolidin-4-one |
| 22 | 4-F | 3,4,5-triOH | S | S | (Z)-3-(4-fluorophenyl)-5-(3,4,5- |
| | phenyl | phenyl | | | trihydroxybenzylidene)-2- |
| | | | | | thioxothiazolidin-4-one |
| 23 | 4-F | 3,5-diOMe, | S | S | (Z)-3-(4-fluorophenyl)-5-(3,5- |
| | phenyl | 4-OH | | | dimethoxy-4- |
| | | phenyl | | | hydroxybenzylidene)- |
| | | | | | 2-thioxothiazolidin-4-one |
| 24 | 4-F | 3-OEt, 4- | S | S | (Z)-3-(4-fluorophenyl)-5-(5- |
| | phenyl | OH, 5-Br | | | bromo-4-hydroxy-3- |
| | | phenyl | | | ethoxybenzylidene)-2- |
| | | | | | thioxothiazolidin-4-one |
| 25 | 4-F | 3-OPr, 4- | S | S | (Z)-3-(4-fluorophenyl)-5-(4- |
| | phenyl | OH phenyl | | | hydroxy-3- |
| | | | | | propoxybenzylidene)- |
| | | | | | 2-thioxothiazolidin-4-one |
| 26 | 4-F | 3-OBu, 4- | S | S | (Z)-3-(4-fluorophenyl)-5-(3- |
| | phenyl | OH phenyl | | | hydroxybenzylidene)-2- |
| | | | | | thioxothiazolidin-4-one |
| 27 | 4-F | 3-OBn, 4- | S | S | (Z)-3-(4-fluorophenyl)-5-(3- |
| | phenyl | OH phenyl | | | benzyloxy-4-hydroxy- |
| | | | | | benzylidene)-2- |
| | | | | | thioxothiazolidin-4-one |
| 28 | 4-F | 3-OiPr, 4- | S | S | (Z)-3-(4-fluorophenyl)-5-(4- |
| | phenyl | OH phenyl | | | hydroxy-3- |
| | | | | | isopropoxybenzylidene)- |
| | | | | | 2-thioxothiazolidin-4-one |
| 29 | 4-F | 3-Oallyl, 4- | S | S | (Z)-3-(4-fluorophenyl)-5-(3- |
| | phenyl | OH phenyl | | | allyloxy-4- |
| | | | | | hydroxybenzylidene)-2- |
| | | | | | thioxothiazolidin-4-one |
| 30 | 4-F | 3-OMe, 4- | S | S | (Z)-3-(4-fluorophenyl)-5- |
| | phenyl | OH, 5-allyl | | | (5-allyl-4-hydroxy-3- |
| | | phenyl | | | methoxybenzylidene)- |
| | | | | | 2-thioxothiazolidin-4-one |
| 31 | 4-F | 3-OEt, 4- | S | S | (Z)-3-(4-fluorophenyl)-5- |
| | phenyl | OMe, 5-allyl | | | (5-allyl-4-hydroxy-3- |
| | | phenyl | | | methoxybenzylidene)- |
| | | | | | 2-thioxothiazolidin-4-one |
| 32 | 4-F | 3- | S | S | (Z)-3-(4-fluorophenyl)-5- |
| | phenyl | Opropargyl, | | | (4-hydroxy-3-(prop-2- |
| | | 4-OH | | | ynyl)oxybenzylidene)-2- |
| | | phenyl | | | thioxothiazolidin-4-one |
| 33 | 4-CN | 3-OEt, 4-OH | S | S | (Z)-3-(4-cyanophenyl)- |
| | phenyl | phenyl | | | 5-(3-hydroxy-4- |
| | | | | | methoxybenzylidene)-2- |
| | | | | | thioxothiazolidin-4-one |
| 34 | 3-CN | 3-OEt, 4-OH | S | S | (Z)-3-(3-cyanophenyl)-5- |
| | phenyl | phenyl | | | (3-hydroxy-4- |
| | | | | | methoxybenzylidene)-2- |
| | | | | | thioxothiazolidin-4-one |
| 35 | 3-CF₃, | 3-OEt, 4-OH | S | S | (Z)-3-(3-trifluoromethyl-4- |
| | 4-F | phenyl | | | fluorophenyl)-5-(3-hydroxy-4- |
| | phenyl | | | | methoxybenzylidene)-2- |
| | | | | | thioxothiazolidin-4-one |
| 36 | (3- | 3-OEt, 4-OH | S | S | (Z)-3-(pyridin-3-yl)-5-(3- |
| | pyridyl) | phenyl | | | hydroxy-4- |
| | | | | | methoxybenzylidene)-2- |
| | | | | | thioxothiazolidin-4-one |
| 37 | 4-CF₃ | 3-OEt, 4-OH | S | S | (Z)-3-(4-trifluoromethylphenyl)- |
| | phenyl | phenyl | | | 5-(3-hydroxy-4- |
| | | | | | methoxybenzylidene)- |
| | | | | | 2-thioxothiazolidin-4-one |
| 38 | 3-CF₃ | 3-OEt, 4-OH | S | S | (Z)-3-(3-trifluoromethylphenyl)- |
| | phenyl | phenyl | | | 5-(3-hydroxy-4- |
| | | | | | methoxybenzylidene)-2- |
| | | | | | thioxothiazolidin-4-one |
| 39 | 3,5- | 3-OEt, 4-OH | S | S | (Z)-3-(3,5-ditrifluoromethyl- |
| | diCF₃ | phenyl | | | phenyl)-5-(3-hydroxy-4- |
| | phenyl | | | | methoxybenzylidene)-2- |
| | | | | | thioxothiazolidin-4-one |
| 40 | 6-F | 3-OEt, 4-OH | S | S | (Z)-3-(6-fluoropyridin-3-yl)-5- |
| | (3- | phenyl | | | (3-hydroxy-4- |
| | pyridyl) | | | | methoxybenzylidene)-2- |
| | | | | | thiothiazolidin-4-one |
| 41 | 6-Cl | 3-OEt, 4-OH | S | S | (Z)-3-(6-chloropyridin-3-yl)-5- |
| | (3- | phenyl | | | (3-hydroxy-4- |
| | pyridyl) | | | | methoxybenzylidene)- |
| | | | | | 2-thiothiazolidin-4-one |
| 42 | 6-CN | 3-OEt, 4-OH | S | S | (Z)-3-(6-cyanopyridin-3-yl)-5-(3- |
| | (3- | phenyl | | | hydroxy-4-methoxybenzylidene)- |
| | pyridyl) | | | | 2-thiothiazolidin-4-one |
| 43 | 2-Cl | 3-OEt, 4-OH | S | S | (Z)-3-(2-chloropyridin-4-yl)-5- |
| | (4- | phenyl | | | (3-hydroxy-4- |
| | pyridyl) | | | | methoxybenzylidene)- |
| | | | | | 2-thioxothiazolidin-4-one |
| 44 | 6-CF₃ (3- | 3-OEt, 4-OH | S | S | (Z)-3-(6-trifluoromethylpyridin-3- |
| | pyridyl) | phenyl | | | yl)-5-(3-hydroxy-4- |
| | | | | | methoxybenzyl- |
| | | | | | idene)-2-thioxothiazolidin-4-one |
| 45 | 5-Cl | 3-OEt, 4-OH | S | S | (Z)-3-(5-chloropyridin-2-yl)-5- |
| | (2- | phenyl | | | (3-hydroxy-4- |
| | pyridyl) | | | | methoxybenzylidene)- |
| | | | | | 2-thioxothiazolidin-4-one |
| 46 | 3,4-diF | 3-OEt, 4-OH | S | S | (Z)-3-(3,4-difluorophenyl)-5-(3- |
| | phenyl | phenyl | | | hydroxy-4-methoxybenzylidene)- |
| | | | | | 2-thioxothiazolidin-4-one |
| 47 | 3,4,5- | 3-OEt, 4-OH | S | S | (Z)-3-(3,4,5-trifluorophenyl)-5- |
| | triF | phenyl | | | (3-hydroxy-4- |
| | phenyl | | | | methoxybenzylidene)- |
| | | | | | 2-thioxothiazolidin-4-one |
| 48 | 5-F, | 3-OEt, 4-OH | S | S | (Z)-3-(5-fluoropyridin-2-yl)-5- |
| | (2- | phenyl | | | (3-hydroxy-4- |
| | pyridyl) | | | | methoxybenzylidene)- |
| | | | | | 2-thioxothiazolidin-4-one |
| 49 | 4- | 3-OEt, 4-OH | S | S | (Z)-3-(4-methoxycarbonyl- |
| | COOMe | phenyl | | | phenyl)-5-(3-hydroxy-4- |
| | phenyl | | | | methoxybenzylidene)- |
| | | | | | 2-thioxothiazolidin-4-one |
| 50 | 4- | 3-OEt, 4-OH | S | S | (Z)-3-(4-ethoxycarbonylphenyl)- |
| | COOEt | phenyl | | | 5-(3-hydroxy-4- |
| | phenyl | | | | methoxybenzylidene)- |
| | | | | | 2-thioxothiazolidin-4-one |
| 51 | 4- | 3-OEt, 4-OH | S | S | (Z)-3-(4-butoxycarbonylphenyl)- |
| | COOBu | phenyl | | | 5-(3-hydroxy-4- |
| | phenyl | | | | methoxybenzylidene)- |
| | | | | | 2-thioxothiazolidin-4-one |
| 52 | 4- | 3-OEt, 4-OH | S | S | (Z)-3-(4-benzyloxy- |
| | COOBn | phenyl | | | carbonylphenyl)- |
| | phenyl | | | | 5-(3-hydroxy-4-methoxybenzyl- |
| | | | | | idene)-2-thioxothiazolidin-4-one |
| 53 | 4-NO₂ | 3-OEt, 4-OH | S | S | (Z)-3-(4-nitrophenyl)-5-(3- |
| | phenyl | phenyl | | | hydroxy-4- |
| | | | | | methoxybenzylidene)-2- |
| | | | | | thioxothiazolidin-4-one |
| 54 | 3- | 3-OEt, 4-OH | S | S | (Z)-3-(3-sulfamoylphenyl)-5-(3- |
| | SO₂NH₂ | phenyl | | | hydoxy-4-methoxybenzylidene)- |
| | phenyl | | | | 2-thioxothiazolidin-4-one |
| 55 | 4- | 3-OEt, 4-OH | S | S | (Z)-3-(4-sulfamoylphenyl)-5-(3- |
| | SO₂NH₂ | phenyl | | | hydroxy-4-methoxybenzylidene)- |
| | phenyl | | | | 2-thioxothiazolidin-4-one |
| 56 | 4- | 3-OEt, 4-OH | S | S | (Z)-3-(4-methylsulfonylphenyl)- |
| | SO₂Me | phenyl | | | 5-(3-hydroxy-4- |
| | phenyl | | | | methoxybenzylidene)- |
| | | | | | 2-thioxothiazolidin-4-one |
| 57 | 3- | 3-OEt, 4-OH | S | S | (Z)-3-(3-methylsulfonylphenyl)- |
| | SO₂Me | phenyl | | | 5-(3-hydroxy-4- |
| | phenyl | | | | methoxybenzylidene)- |
| | | | | | 2-thioxothiazolidin-4-one |
| 58 | 4-F | 3-OEt, 4-OH | O | NH | (Z)-3-(4-fluorophenyl)-5- |
| | phenyl | phenyl | | | (3-hydroxy-4-ethoxy- |
| | | | | | benzylidene)imidazolidine- |
| | | | | | 2,4-dione |
| 59 | 4-Cl | 3-OEt, 4-OH | O | NH | (Z)-3-(4-chlorophenyl)-5- |
| | phenyl | phenyl | | | (3-hydroxy-4-ethoxy- |
| | | | | | benzylidene)imidazolidine- |
| | | | | | 2,4-dione |
| 60 | 4-F | 3-OEt, 4-OH | O | S | (Z)-3-(4-fluorophenyl)-5- |
| | phenyl | phenyl | | | (3-hydroxy-4-ethoxy- |
| | | | | | benzylidene)thiazolidine- |
| | | | | | 2,4-dione |
| 61 | 4-Cl | 3-OEt, 4-OH | O | S | (Z)-3-(4-chlorophenyl)-5-(3- |
| | phenyl | phenyl | | | hydroxy-4-ethoxybenzylidene) |
| | | | | | thiazolidine-2,4-dione |
| 62 | 4-F | 3-OEt, 4-OH | S | NH | (Z)-3-(4-fluorophenyl)-5-(3- |
| | phenyl | phenyl | | | hydroxy-4-ethoxybenzylidene)-2- |
| | | | | | thioxoimidazolidin-4-one |

### Example 4

### Characterization of Anti-Biofilm Activity of Synthesized Compounds

Minimal Biofilm Inhibitory Concentration (MBIC) and Minimal Inhibitory Concentration (MIC) of the compounds in Table 3 were determined against various strains of biofilm-forming bacteria.

Anti-biofilm activity data for seven rhodanine compounds from Table 3 against selected biofilm-forming strains of S. epidermidis strains are shown in Table 4.

TABLE 4
Anti-Biofilm Activity Against Selected Strains of Staphylococcus
epidermidis

| | S. epidermidis strain | | | | | | | |
|---|---|---|---|---|---|---|---|---|
| | 18972 | | 1457 | | O47 | | 35894 | |
| | MIC | MBIC | MIC | MBIC | MIC | MBIC | MIC | MBIC |
| No. | (μM) | (μM) | (μM) | (μM) | (μM) | (μM) | (μM) | (μM) |
| 4 | ≧100 | 25 | ≧100 | 50 | ≧100 | 12.5 | ≧100 | 25 |
| 8 | ≧100 | 50 | ≧100 | 50 | ≧100 | 25 | ≧100 | 25 |
| 36 | ≧100 | 12.5 | ≧100 | 12.5 | ≧100 | 50 | ≧100 | 12.5 |
| 29 | ≧100 | 25 | ≧100 | 25 | ≧100 | 12.5 | ≧100 | 25 |
| 40 | ≧100 | 25 | ≧100 | 25 | ≧100 | 6.3 | ≧100 | 6.3 |
| 34 | ≧100 | 25 | ≧100 | ≧100 | ≧100 | 1.6 | ≧100 | 12.5 |
| 49 | ≧100 | 12.5 | ≧100 | 50 | ≧100 | 0.8 | ≧100 | 6.3 |

Table 5, below, shows anti-biofilm activity data for the same seven rhodanine compounds from Table 3 against selected biofilm-forming strains of S. aureus, including a strain of methicillin-susceptible S. aureus (MSSA).

TABLE 5
Anti-Biofilm Activity Against Selected Strains of Staphylococcus aureus

| | S. aureus strain | | | | | | | |
|---|---|---|---|---|---|---|---|---|
| | 35556 | | NRS-77 | | NRS-123 | | MSSA | |
| | MIC | MBIC | MIC | MBIC | MIC | MBIC | MIC | MBIC |
| No. | (μM) | (μM) | (μM) | (μM) | (μM) | (μM) | (μM) | (μM) |
| 4 | ≧100 | 3.1 | ≧100 | 25 | ≧100 | 25 | ≧100 | 12.5 |
| 8 | ≧100 | 6.3 | ≧100 | 25 | ≧100 | 25 | ≧100 | 25 |
| 36 | ≧100 | 12.5 | ≧100 | 12.5 | ≧100 | 12.5 | ≧100 | 12.5 |
| 29 | ≧100 | 3.1 | ≧100 | 12.5 | ≧100 | 25 | ≧100 | 12.5 |
| 40 | ≧100 | 6.3 | ≧100 | 6.3 | ≧100 | 50 | ≧100 | 6.3 |
| 34 | ≧100 | 1.6 | ≧100 | 12.5 | ≧100 | 25 | ≧100 | 12.5 |
| 49 | ≧100 | 0.8 | ≧100 | 12.5 | ≧100 | 25 | ≧100 | 12.5 |

Compounds were also tested for anti-biofilm activity against a strain of biofilm-forming, vancomycin-resistant Enterococcus faecalis strain (ATCC 51299), the Gram-negative biofilm-forming opportunistic pathogen Pseudomonas aeruginosa PAO1 (ATCC 35556), and a Gram-negative, biofilm-forming strain of Escherichia coli (ATCC 25922). Table 6, below, shows anti-biofilm activity data for the seven rhodanine compounds from Table 3 against these other bacterial strains. None of the compounds showed activity against biofilm formation or planktonic growth of the strains of P. aeruginosa and E. coli under the assay conditions.

TABLE 6
Anti-Biofilm Activity Against Gram-positive and Gram-negative
Bacterial Strains

| | E. faecalis | | P. aeruginosa | | E. coli | |
|---|---|---|---|---|---|---|
| | strain | | strain | | strain | |
| | 51299 | | PA01 | | 25922 | |
| | MIC | MBIC | MIC | MBIC | MIC | MBIC |
| No. | (μM) | (μM) | (μM) | (μM) | (μM) | (μM) |
| 4 | ≧100 | 12.5 | ≧100 | ≧100 | ≧100 | ≧100 |
| 8 | ≧100 | 25 | ≧100 | ≧100 | ≧100 | ≧100 |
| 36 | ≧100 | 12.5 | ≧100 | ≧100 | ≧100 | ≧100 |
| 29 | ≧100 | 12.5 | ≧100 | ≧100 | ≧100 | ≧100 |
| 40 | ≧100 | 6.3 | ≧100 | ≧100 | ≧100 | ≧100 |
| 34 | ≧100 | 12.5 | ≧100 | ≧100 | ≧100 | ≧100 |
| 49 | ≧100 | 12.5 | ≧100 | ≧100 | ≧100 | ≧100 |

Compounds in Tables 4-6 also exhibited anti-biofilm activity (MBIC of 25 μM or less) against at least one strain of Enterococcus faecium and Enterococcus gallinarum, which are biofilm-forming Gram-positive pathogens. (Data not shown.) In addition, other compounds of Table 3 exhibited a MBIC of 25 μM or less against at least one of the strains of biofilm-forming, Gram-positive bacteria listed in Tables 4-6. (Data not shown.)

### Example 5

### Anti-Biofilm Rhodanines Inhibit the Early Stages of Biofilm Development

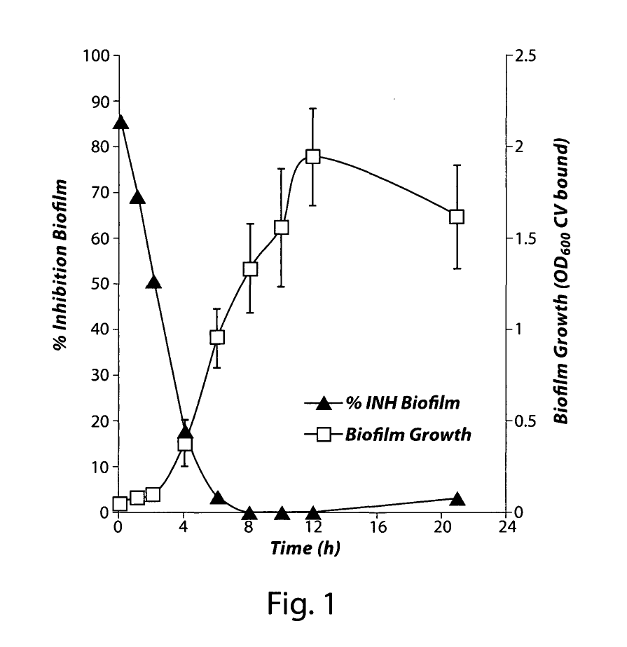

In order to verify that the rhodanine anti-biofilm compounds specifically inhibit biofilm formation (biofilm growth), the inhibitory effect of Compound 4 (MBIC=3.125 μM) on biofilm growth at various stages of biofilm development was determined. In this experiment, wells of a 96-well assay plate containing growth medium (0.5×TSB, 0.25% (w/v) glucose) were inoculated with S. aureus ATCC 35556 and incubated at 37° C. At selected times (0, 1, 2, 4, 6, 8, 10, 12, 21 hours) during the incubation period, Compound 4 was added to individual wells at a concentration of 4×MBIC. Biofilms were washed and stained with crystal violet (CV) to measure biofilm growth after the entire assay plate (all cultures) had been incubated for a total of 22 hours. Biofilm growth in the absence of Compound 4 was followed in parallel cultures (untreated control cultures). Samples were taken from untreated cultures at the same times as Compound 4 was added to the inhibition cultures to quantify the level of biofilm growth by the CV staining method. The results of this experiment are shown in the graph in FIG. 1, where the percent inhibition of biofilm growth in cultures treated with Compound 4 and biofilm growth in untreated control cultures are plotted as a function of the time. Each time point in FIG. 1 is the average of 8 cultures.

The data show that Compound 4 inhibited the early stages (up to 2 h) of biofilm formation, whereas maturing biofilms (8-16 h) were resistant. These results indicate that the rhodanine compounds are particularly effective at inhibiting the early stages of biofilm development.

### Example 6

### Anti-Biofilm Rhodanines Specifically Inhibit Biofilm Growth

The results of the MIC assays clearly demonstrated that the majority of rhodanines do not inhibit planktonic bacterial cell growth. However, the specificity of these compounds for inhibiting biofilm growth was verified using an alternative growth curve assay. Planktonic cultures of S. aureus ATCC 35556 were grown aerobically in the presence of various concentrations of Compound 4 (MBIC=3.125 μM). Bacterial cell growth was monitored over time by measuring OD₆₀₀. The results (data not shown), demonstrate that Compound 4 did not affect planktonic bacterial cell growth at concentrations up to 8×MBIC.

Overall, the data of the above studies indicate that the compounds from the library screenings and the synthesized compounds in Table 3 are useful as potent inhibitors of S. epidermidis and S. aureus biofilm formation. Such compounds may be used in compositions and methods to inhibit biofilm development on surfaces of medical devices as well as in other applications where bacterial biofilm formation poses a threat to human or animal health.

All publications, patent applications, patents, and other documents cited herein are incorporated by reference in their entirety. In case of conflict, the present specification, including definitions, will control. In addition, the materials, methods, and examples are illustrative only and not intended to be limiting.

Other variations and embodiments of the invention described herein will now be apparent to those of ordinary skill in art without departing from the scope of the invention or the spirit of the claims below.

1. A method of inhibiting biofilm formation by bacterial cells on a solid surface comprising the step of contacting the surface with a compound that has the structure of Formula 1: 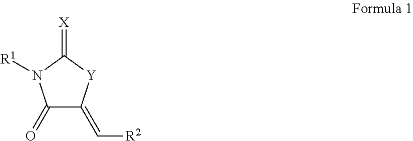
wherein
X is sulfur (S) or oxygen (O):
Y is sulfur (S) or nitrogen (NH);
R¹ is:
a) a substituted phenyl group, wherein the phenyl group is substituted at one or more of positions 3, 4, and 5, with a radical selected from the group consisting of halo (fluoro, chloro, bromo, or iodo); cyano (—CN); the carboxy group —COOR⁵, wherein R⁵ is H or alkyl; —CF₃ (trifluoromethyl); the nitro group (—NO₂); the sulfonyl group —SO₂R⁶, wherein R⁶ is alkyl; the sulfonamidyl group —SO₂NH₂; and the keto group —C(O)R⁷, wherein C(O) is a carbonyl group and R⁷ is hydrogen or alkyl;
and wherein said phenyl group is not substituted at positions 2 and 6;
or
b) a substituted heteroaryl group, wherein the heteroaryl group is pyridinyl, pyrazinyl, pyrimidinyl, or pyridazinyl, and wherein said heteroaryl group is substituted at one or more ring carbons with any of the group consisting of halo (fluoro, chloro, bromo, or iodo); cyano (—CN); the carboxy group —COOR⁵, wherein R⁵ is H or alkyl; —CF₃ (trifluoromethyl); the sulfonyl group —SO₂R⁶, wherein R⁶ is alkyl; the sulfonamidyl group —SO₂NH₂; and the keto group —C(O)R⁷, wherein C(O) is a carbonyl group and R⁷ is hydrogen or alkyl;
and
R² is a substituted phenyl group,
wherein the phenyl group is substituted with a radical at one or more positions selected from the group consisting of:
a) substitution at position 4 with hydroxyl (—OH) or amino (—NH₂);
b) substitution at position 3 with a radical selected from the group consisting of hydroxyl; the alkoxy radical —OR⁸, wherein R⁸ is alkyl, alkenyl, or alkynyl; and the amino group —NR⁹R¹⁰, wherein R⁹ and R¹⁰ are, independently, H, alkyl, alkenyl, or alkynyl; and
c) substitution at position 5 with a radical selected from the group consisting of halo (fluoro, chloro, bromo, or iodo); alkyl; alkenyl; alkynyl; hydroxyl; the alkoxy radical —OR⁸, wherein R⁸ is alkyl, alkenyl, or alkynyl; cyano; the group —NR⁹R¹⁰, wherein R⁹ and R¹⁰ are, independently, H, alkyl, alkenyl, or alkynyl; the carboxy group —COOR⁵, wherein R⁵ is H or alkyl; —CF₃ (trifluoromethyl); the sulfonyl group —SO₂R⁶, wherein R⁶ is alkyl; —SO₂NH₂ (sulfonamidyl); the keto group —C(O)R⁷, wherein C(O) is a carbonyl group and R⁷ is hydrogen or alkyl;
and wherein the phenyl group has no substitutions at positions 2 and 6;
wherein said compound inhibits bacterial biofilm formation.

2. The method according to claim 1, wherein said compound is a rhodanine compound that has the structure of Formula 2: 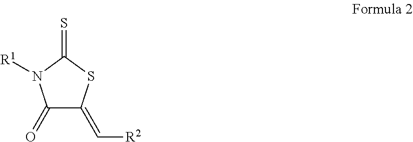
wherein R¹ and R² are as described in claim 1;
and wherein said compound inhibits bacterial biofilm formation.

3. The method according to claim 2, wherein said rhodanine compound is selected from the group consisting of: 3-(3-chlorophenyl)-5-(3-bromo-4-hydroxy-5-methoxy-benzylidene)-2-thioxothiazolidin-4-one (MSL-049731 in Table 2), 3-(4-bromophenyl)-5-(3-ethoxy-4-hydroxybenzylidene)-2-thioxothiazolidin-4-one (MSL-049293 in Table 2), 3-(4-chlorophenyl)-5-(3-chloro-5-ethoxy-4-hydroxybenzylidene)thiazolidine-2,4-dione (MSL-6519056 in Table 2), (Z)-3-(4-fluorophenyl)-5-(3-hydroxy-4-ethoxybenzylidene)-2-thioxothiazolidin-4-one (Compound 4 in Table 3), (Z)-3-(3-fluorophenyl)-5-(3-hydroxy-4-ethoxybenzylidene)-2-thioxothiazolidin-4-one (Compound 8 in Table 3), (Z)-3-(4-fluorophenyl)-5-(3-allyloxy-4-hydroxybenzylidene)-2-thioxothiazolidin-4-one (Compound 29 in Table 3), (Z)-3-(3-cyanophenyl)-5-(3-hydroxy-4-methoxybenzylidene)-2-thioxothiazolidin-4-one (Compound 34 in Table 3), (Z)-3-(pyridin-3-yl)-5-(3-hydroxy-4-methoxybenzylidene)-2-thioxothiazolidin-4-one (Compound 36 in Table 3), (Z)-3-(6-fluoropyridin-3-yl)-5-(3-hydroxy-4-methoxybenzylidene)-2-thioxothiazolidin-4-one (Compound 40 in Table 3), and (Z)-3-(4-methoxycarbonylphenyl)-5-(3-hydroxy-4-methoxybenzylidene)-2-thioxothiazolidin-4-one (Compound 49 in Table 3).

4. The method according to claim 1, wherein said compound is a thiazolidinedione compound that has the structure of Formula 3: 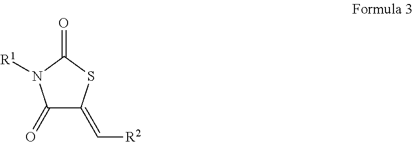
wherein R¹ and R² are as described in claim 1;
and wherein said compound inhibits bacterial biofilm formation.

5. The method according to claim 4, wherein the thiazolidinedione compound is (Z)-3-(4-fluorophenyl)-5-(3-hydroxy-4-ethoxybenzylidene)thiazolidine-2,4-dione (Compound 60 in Table 3) or (Z)-3-(4-chlorophenyl)-5-(3-hydroxy-4-ethoxybenzylidene)thiazolidine-2,4-dione (Compound 61 in Table 3).

6. The method according to claim 1, wherein said compound is a hydantoin compound that has the structure of Formula 4: 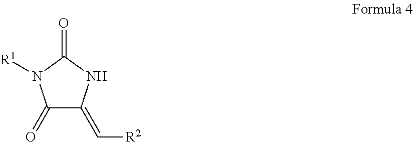
wherein R¹ and R² are as described in claim 1;
and wherein said compound inhibits bacterial biofilm formation.

7. The method according to claim 6, wherein said hydantoin compound is (Z)-3-(4-fluorophenyl)-5-(3-hydroxy-4-ethoxybenzylidene)imidazolidine-2,4-dione (Compound 58 in Table 3) or (Z)-3-(4-chlorophenyl)-5-(3-hydroxy-4-ethoxybenzylidene)imidazolidine-2,4-dione (Compound 59 in Table 3).

8. The method according to claim 1, wherein said compound is a thiohydantoin compound that has the structure of Formula 5: 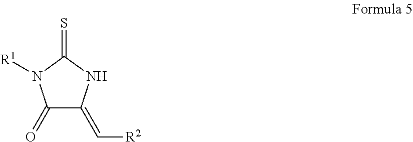
wherein R¹ and R² are as described in claim 1;
and wherein said compound inhibits bacterial biofilm formation.

9. The method according to claim 8, wherein said thiohydantoin compound is (Z)-3-(4-fluorophenyl)-5-(3-hydroxy-4-ethoxybenzylidene)-2-thioxoimidazolidin-4-one (Compound 62 in Table 3).

10. A method of inhibiting biofilm formation by bacterial cells on a surface comprising contacting the surface with a furanone compound that has the structure of Formula 6: 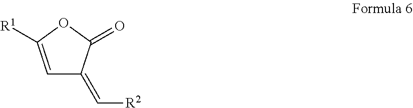
wherein:
R¹ is:
a) a substituted phenyl group, wherein the phenyl group is substituted at one or more of positions 3, 4, and 5, with a radical selected from the group consisting of halo; cyano (—CN); the carboxy group —COOR⁵, wherein R⁵ is H or alkyl; —CF₃ (trifluoromethyl); the sulfonyl group —SOOR⁶, wherein R⁶ is alkyl; the sulfonamidyl group —SOONH₂; and the keto group —C(O)R⁷, wherein C(O) is a carbonyl group and R⁷ is hydrogen or alkyl;
and wherein said phenyl group is not substituted at positions 2 and 6;
or
b) a substituted heteroaryl group, wherein the heteroaryl group is pyridinyl, pyrazinyl, pyrimidinyl, or pyridazinyl, and wherein said heteroaryl group is substituted at one or more ring carbons with any of the group consisting of halo;
cyano (—CN); the carboxy group —COOR⁵, wherein R⁵ is H or alkyl; —CF₃ (trifluoromethyl); the sulfonyl group —SOOR⁶, wherein R⁶ is alkyl; the sulfonamidyl group —SOONH₂; and the keto group —C(O)R⁷, wherein C(O) is a carbonyl group and R⁷ is hydrogen or alkyl;
and
R² is a substituted phenyl group,
wherein the phenyl group is substituted with a radical at one or more positions selected from the group consisting of:
a) substitution at position 4 with hydroxyl (—OH) or amino (—NH₂);
b) substitution at position 3 with a radical selected from the group consisting of hydroxyl; the alkoxy radical —OR⁸, wherein R⁸ is alkyl, alkenyl, or alkynyl; and the amino group —NR⁹R¹⁰, wherein R⁹ and R¹⁰ are, independently, H, alkyl, alkenyl, or alkynyl; and
c) substitution at position 5 with a radical selected from the group consisting of halo; alkyl; alkenyl; alkynyl; hydroxyl; the alkoxy radical —OR⁸, wherein R⁸ is alkyl, alkenyl, or alkynyl; cyano; the group —NR⁹R¹⁰, wherein R⁹ and R¹⁰ are, independently, H, alkyl, alkenyl, or alkynyl; the carboxy group —COOR⁵, wherein R⁵ is H or alkyl; —CF₃ (trifluoromethyl); the sulfonyl group —SOOR⁶, wherein R⁶ is alkyl; —SOONH₂ (sulfonamidyl); the keto group —C(O)R⁷, wherein C(O) is a carbonyl group and R⁷ is hydrogen or alkyl;
and wherein the phenyl group has no substitutions at positions 2 and 6;
wherein the compound inhibits bacterial biofilm formation.

11. The method according to claim 10, wherein the furanone compound is 3-(4-hydroxy-3-methoxybenzylidene)-5-(2,4-dimethoxyphenyl)furan-2(3H)-one (MSL-051097 in Table 2).

12. A composition comprising:
a biofilm inhibitor compound that has the structure of Formula 1: 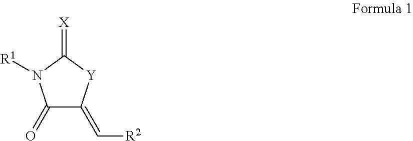
wherein:
X is sulfur (S) or oxygen (O):
Y is sulfur (S) or nitrogen (NH);
R¹ is:
a) a substituted phenyl group, wherein the phenyl group is substituted at one or more of positions 3, 4, and 5, with a radical selected from the group consisting of halo; cyano (—CN); the carboxy group —COOR⁵, wherein R⁵ is H or alkyl; —CF₃ (trifluoromethyl); the sulfonyl group —SOOR⁶, wherein R⁶ is alkyl; the sulfonamidyl group —SOONH₂; and the keto group —C(O)R⁷, wherein C(O) is a carbonyl group and R⁷ is hydrogen or alkyl;
and wherein said phenyl group is not substituted at positions 2 and 6;
or
b) a substituted heteroaryl group, wherein the heteroaryl group is pyridinyl, pyrazinyl, pyrimidinyl, or pyridazinyl, and wherein said heteroaryl group is substituted at one or more ring carbons with any of the group consisting of halo; cyano (—CN); the carboxy group —COOR⁵, wherein R⁵ is H or alkyl;
—CF₃ (trifluoromethyl); the sulfonyl group —SOOR⁶, wherein R⁶ is alkyl; the sulfonamidyl group —SOONH₂; and the keto group —C(O)R⁷, wherein C(O) is a carbonyl group and R⁷ is hydrogen or alkyl;
and
R² is a substituted phenyl group,
wherein the phenyl group is substituted with a radical at one or more positions selected from the group consisting of:
a) substitution at position 4 with hydroxyl (—OH) or amino (—NH₂);
b) substitution at position 3 with a radical selected from the group consisting of hydroxyl; the alkoxy radical —OR⁸, wherein R⁸ is alkyl, alkenyl, or alkynyl; and the amino group —NR⁹R¹⁰, wherein R⁹ and R¹⁰ are, independently, H, alkyl, alkenyl, or alkynyl; and
c) substitution at position 5 with a radical selected from the group consisting of halo; alkyl; alkenyl; alkynyl; hydroxyl; the alkoxy radical —OR⁸, wherein R⁸ is alkyl, alkenyl, or alkynyl; cyano; the group —NR⁹R¹⁰, wherein R⁹ and R¹⁰ are, independently, H, alkyl, alkenyl, or alkynyl; the carboxy group —COOR⁵, wherein R⁵ is H or alkyl; —CF₃ (trifluoromethyl); the sulfonyl group —SOOR⁶, wherein R⁶ is alkyl; —SOONH₂ (sulfonamidyl); the keto group —C(O)R⁷, wherein C(O) is a carbonyl group and R⁷ is hydrogen or alkyl;
and wherein the phenyl group has no substitutions at positions 2 and 6;
wherein said compound inhibits bacterial biofilm formation;
a carrier;
optionally, an antibacterial growth agent; and
optionally, an excipient.

13. The biofilm inhibitor composition according to claim 12, wherein said biofilm inhibitor compound is a rhodanine compound that has the structure of Formula 2: 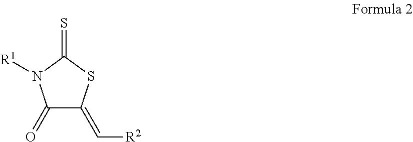
wherein R¹ and R² are as described in claim 12;
wherein said compound inhibits bacterial biofilm formation.

14. The biofilm inhibitor composition according to claim 13, wherein said rhodanine compound is selected from the group consisting of: is 3-(3-chlorophenyl)-5-(3-bromo-4-hydroxy-5-methoxy-benzylidene)-2-thioxothiazolidin-4-one (MSL-049731 in Table 2), 3-(4-bromophenyl)-5-(3-ethoxy-4-hydroxybenzylidene)-2-thioxothiazolidin-4-one (MSL-049293 in Table 2), 3-(4-chlorophenyl)-5-(3-chloro-5-ethoxy-4-hydroxybenzylidene) thiazolidine-2,4-dione (MSL-6519056 in Table 2), (Z)-3-(4-fluorophenyl)-5-(3-hydroxy-4-ethoxybenzylidene)-2-thioxothiazolidin-4-one (Compound 4 in Table 3), (Z)-3-(3-fluorophenyl)-5-(3-hydroxy-4-ethoxybenzylidene)-2-thioxothiazolidin-4-one (Compound 8 in Table 3), (Z)-3-(4-fluorophenyl)-5-(3-allyloxy-4-hydroxybenzylidene)-2-thioxothiazolidin-4-one (Compound 29 in Table 3), (Z)-3-(3-cyanophenyl)-5-(3-hydroxy-4-methoxybenzylidene)-2-thioxothiazolidin-4-one (Compound 34 in Table 3), (Z)-3-(pyridin-3-yl)-5-(3-hydroxy-4-methoxybenzylidene)-2-thioxothiazolidin-4-one (Compound 36 in Table 3), (Z)-3-(6-fluoropyridin-3-yl)-5-(3-hydroxy-4-methoxybenzylidene)-2-thioxothiazolidin-4-one (Compound 40 in Table 3), and (Z)-3-(4-methoxycarbonylphenyl)-5-(3-hydroxy-4-methoxybenzylidene)-2-thioxothiazolidin-4-one (Compound 49 in Table 3).

15. The biofilm inhibitor composition according to claim 12, wherein said biofilm inhibitor compound is a thiazolidinedione compound that has the structure of Formula 3: 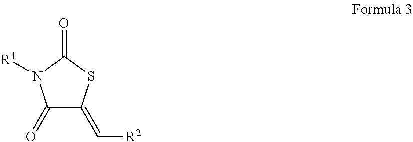
wherein R¹ and R² are as described in claim 12;
wherein said compound inhibits bacterial biofilm formation.

16. The biofilm inhibitor composition according to claim 15, wherein said thiazolidinedione compound is 3-(4-chlorophenyl)-5-(3-chloro-5-ethoxy-4-hydroxybenzylidene)thiazolidine-2,4-dione, designated MSL-6519056.

17. The biofilm inhibitor composition according to claim 12, wherein said biofilm inhibitor compound is a hydantoin compound that has the structure of Formula 4: 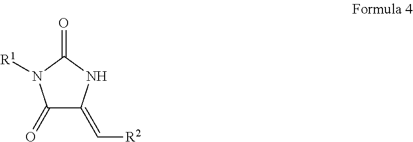
wherein R¹ and R² are as described in claim 12;
wherein said compound inhibits bacterial biofilm formation.

18. The biofilm inhibitor composition according to claim 17, wherein said hydantoin compound is (Z)-3-(4-fluorophenyl)-5-(3-hydroxy-4-ethoxybenzylidene)imidazolidine-2,4-dione (Compound 58 in Table 3) or (Z)-3-(4-chlorophenyl)-5-(3-hydroxy-4-ethoxybenzylidene)imidazolidine-2,4-dione (Compound 59 in Table 3).

19. The biofilm inhibitor composition according to claim 12, wherein said biofilm inhibitor compound is a thiohydantoin compound that has the structure of Formula 5: 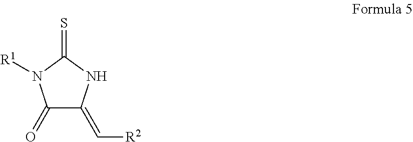
wherein R¹ and R² are as described in claim 12;
wherein said compound inhibits bacterial biofilm formation.

20. The biofilm inhibitor composition according to claim 19, wherein said thiohydantoin compound is (Z)-3-(4-fluorophenyl)-5-(3-hydroxy-4-ethoxybenzylidene)-2-thioxoimidazolidin-4-one (Compound 62 in Table 3).

21. A biofilm inhibitor composition comprising:
a biofilm inhibitor compound that is a furanone compound that has the structure of Formula 6: 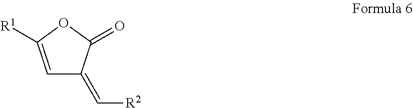
wherein:
R¹ is:
a) a substituted phenyl group, wherein the phenyl group is substituted at one or more of positions 3, 4, and 5, with a radical selected from the group consisting of halo (fluoro, chloro, bromo, or iodo); cyano (—CN); the carboxy group —COOR⁵, wherein R⁵ is H or alkyl; —CF₃ (trifluoromethyl); the nitro group (—NO₂); the sulfonyl group —SO₂R⁶, wherein R⁶ is alkyl; the sulfonamidyl group —SO₂NH₂; and the keto group —C(O)R⁷, wherein C(O) is a carbonyl group and R⁷ is hydrogen or alkyl;
and wherein said phenyl group is not substituted at positions 2 and 6;
or
b) a substituted heteroaryl group, wherein the heteroaryl group is pyridinyl, pyrazinyl, pyrimidinyl, or pyridazinyl, and wherein said heteroaryl group is substituted at one or more ring carbons with any of the group consisting of halo (fluoro, chloro, bromo, or iodo); cyano (—CN); the carboxy group —COOR⁵, wherein R⁵ is H or alkyl; —CF₃ (trifluoromethyl); the sulfonyl group —SO₂R⁶, wherein R⁶ is alkyl; the sulfonamidyl group —SO₂NH₂; and
the keto group —C(O)R⁷, wherein C(O) is a carbonyl group and R⁷ is hydrogen or alkyl;
and
R² is a substituted phenyl group,
wherein the phenyl group is substituted with a radical at one or more positions selected from the group consisting of:
a) substitution at position 4 with hydroxyl (—OH) or amino (—NH₂);
b) substitution at position 3 with a radical selected from the group consisting of hydroxyl; the alkoxy radical —OR⁸, wherein R⁸ is alkyl, alkenyl, or alkynyl; and the amino group —NR⁹R¹⁰, wherein R⁹ and R¹⁰ are, independently, H, alkyl, alkenyl, or alkynyl; and
c) substitution at position 5 with a radical selected from the group consisting of halo (fluoro, chloro, bromo, or iodo); alkyl; alkenyl; alkynyl; hydroxyl; the alkoxy radical —OR⁸, wherein R⁸ is alkyl, alkenyl, or alkynyl; cyano; the group —NR⁹R¹⁰, wherein R⁹ and R¹⁰ are, independently, H, alkyl, alkenyl, or alkynyl; the carboxy group —COOR⁵, wherein R⁵ is H or alkyl; —CF₃ (trifluoromethyl); the sulfonyl group —SO₂R⁶, wherein R⁶ is alkyl; —SO₂NH₂ (sulfonamidyl); the keto group —C(O)R⁷, wherein C(O) is a carbonyl group and R⁷ is hydrogen or alkyl;
and wherein the phenyl group has no substitutions at positions 2 and 6.
wherein said compound inhibits bacterial biofilm formation;
a carrier;
optionally, an antibacterial growth agent; and
optionally, an excipient.

22. The biofilm inhibitor composition according to claim 21, wherein said furanone compound is 3-(4-hydroxy-3-methoxybenzylidene)-5-(2,4-dimethoxyphenyl)furan-2(3H)-one, designated MSL-051097.
